(19) United States
(12) Patent Application Publication
(10) Pub. No.: US 2026/0093500 A1
(43) Pub. Date: Apr. 2, 2026

(54) TECHNIQUES FOR ADDING ACCESSORIES TO ECOSYSTEMS

(71) Applicant: Apple, Inc., Cupertino, CA (US)

(72) Inventors: Keith W. RAUENBUEHLER, San Francisco, CA (US); Jared S. GRUBB, Seattle, WA (US); Daniel G. ROMANO, San Jose, CA (US); Christopher J. LEE, Los Altos, CA (US); Michael A. BEBENITA, San Francisco, CA (US); Zaka U. ASHRAF, Pleasanton, CA (US); Shivesh MAKHARIA, Los Gatos, CA (US)

(21) Appl. No.: 19/075,331

(22) Filed: Mar. 10, 2025

Related U.S. Application Data
(60) Provisional application No. 63/700,533, filed on Sep. 27, 2024.
(60) Provisional application No. 63/728,407, filed on Dec. 5, 2024.

(51) Int. Cl. G06F 9/4401; G06F 8/61; G06F 9/451; G06F 21/31

(52) U.S. Cl. CPC G06F 9/4411; G06F 8/61; G06F 9/451; G06F 21/31

(57) ABSTRACT

The present disclosure generally relates to adding an accessory to an ecosystem. Some techniques are for temporarily installing an application to add an accessory to an ecosystem in accordance with some embodiments. Other techniques are for commissioning an accessory by an installer device in accordance with some embodiments. Other techniques are for commissioning an accessory by a resident device in accordance with some embodiments.

### CROSS-REFERENCE TO RELATED APPLICATIONS

This application claims priority to U.S. Provisional Patent Application Ser. No. 63/728,407, entitled “TECHNIQUES FOR ADDING ACCESSORIES TO ECOSYSTEMS” filed Dec. 5, 2024, and to U.S. Provisional Patent Application Ser. No. 63/700,533, entitled “TECHNIQUES FOR ADDING ACCESSORIES TO ECOSYSTEMS” filed Sep. 27, 2024, which are hereby incorporated by reference in their entireties for all purposes.

### BACKGROUND

Electronic devices are becoming increasingly interconnected. For example, controllers (e.g., user devices and/or computer systems) are often connected to accessories (e.g., a speaker, a fan, and a thermostat) in the home or office. Setting up such electronic devices has become more difficult as the configurations of those connections have become more complicated. Accordingly, there is a need to improve techniques for adding an accessory to an ecosystem.

### SUMMARY

Current techniques for adding an accessory to an ecosystem are generally ineffective and/or inefficient. For example, some techniques require users manually move between multiple different applications in order to add an accessory to an ecosystem. This disclosure provides more effective and/or efficient techniques for adding an accessory to an ecosystem using examples of a vacuum being added to a home ecosystem. It should be recognized that other types of electronic devices can be used with techniques described herein. For example, a smartphone can be connected with a laptop using techniques described herein. In addition, techniques optionally complement or replace other techniques for adding an accessory to an ecosystem.

Some techniques are described herein for adding an accessory device to an ecosystem using a temporary application. Other techniques are described herein for commissioning an accessory device on a set of one or more security domains. Other techniques are described herein for recommissioning an accessory device on different sets of one or more security domains.

In some embodiments, a method that is performed at a computer system that is in communication with one or more input devices is described. In some embodiments, the method comprises: detecting, via the one or more input devices, an input corresponding to a request to add an accessory device to an ecosystem corresponding to a first application; in response to detecting the input corresponding to the request to add the accessory device to the ecosystem, initiating a process to add the accessory device to the ecosystem, wherein the process to add the accessory device to the ecosystem includes: in accordance with a determination that a second application is not installed on the computer system, initiating a process to install the second application, wherein the second application corresponds to the accessory device, and wherein the second application is different from the first application; and in accordance with a determination that the second application is installed on the computer system, forgoing initiation of the process to install the second application; and after installing the second application as part of the process to add the accessory device to the ecosystem and in accordance with a determination that a set of one or more automatic removal criteria is satisfied, removing the second application without detecting a user input to remove the second application.

In some embodiments, a non-transitory computer-readable storage medium storing one or more programs configured to be executed by one or more processors of a computer system that is in communication with one or more input devices is described. In some embodiments, the one or more programs includes instructions for: detecting, via the one or more input devices, an input corresponding to a request to add an accessory device to an ecosystem corresponding to a first application; in response to detecting the input corresponding to the request to add the accessory device to the ecosystem, initiating a process to add the accessory device to the ecosystem, wherein the process to add the accessory device to the ecosystem includes: in accordance with a determination that a second application is not installed on the computer system, initiating a process to install the second application, wherein the second application corresponds to the accessory device, and wherein the second application is different from the first application; and in accordance with a determination that the second application is installed on the computer system, forgoing initiation of the process to install the second application; and after installing the second application as part of the process to add the accessory device to the ecosystem and in accordance with a determination that a set of one or more automatic removal criteria is satisfied, removing the second application without detecting a user input to remove the second application.

In some embodiments, a transitory computer-readable storage medium storing one or more programs configured to be executed by one or more processors of a computer system that is in communication with one or more input devices is described. In some embodiments, the one or more programs includes instructions for: detecting, via the one or more input devices, an input corresponding to a request to add an accessory device to an ecosystem corresponding to a first application; in response to detecting the input corresponding to the request to add the accessory device to the ecosystem, initiating a process to add the accessory device to the ecosystem, wherein the process to add the accessory device to the ecosystem includes: in accordance with a determination that a second application is not installed on the computer system, initiating a process to install the second application, wherein the second application corresponds to the accessory device, and wherein the second application is different from the first application; and in accordance with a determination that the second application is installed on the computer system, forgoing initiation of the process to install the second application; and after installing the second application as part of the process to add the accessory device to the ecosystem and in accordance with a determination that a set of one or more automatic removal criteria is satisfied, removing the second application without detecting a user input to remove the second application.

In some embodiments, a computer system configured to communicate with one or more input devices is described. In some embodiments, the computer system comprises one or more processors and memory storing one or more programs configured to be executed by the one or more processors. In some embodiments, the one or more programs includes instructions for: detecting, via the one or more input devices, an input corresponding to a request to add an accessory device to an ecosystem corresponding to a first application; in response to detecting the input corresponding to the request to add the accessory device to the ecosystem, initiating a process to add the accessory device to the ecosystem, wherein the process to add the accessory device to the ecosystem includes: in accordance with a determination that a second application is not installed on the computer system, initiating a process to install the second application, wherein the second application corresponds to the accessory device, and wherein the second application is different from the first application; and in accordance with a determination that the second application is installed on the computer system, forgoing initiation of the process to install the second application; and after installing the second application as part of the process to add the accessory device to the ecosystem and in accordance with a determination that a set of one or more automatic removal criteria is satisfied, removing the second application without detecting a user input to remove the second application.

In some embodiments, a computer system configured to communicate with one or more input devices is described. In some embodiments, the computer system comprises means for performing each of the following steps: detecting, via the one or more input devices, an input corresponding to a request to add an accessory device to an ecosystem corresponding to a first application; in response to detecting the input corresponding to the request to add the accessory device to the ecosystem, initiating a process to add the accessory device to the ecosystem, wherein the process to add the accessory device to the ecosystem includes: in accordance with a determination that a second application is not installed on the computer system, initiating a process to install the second application, wherein the second application corresponds to the accessory device, and wherein the second application is different from the first application; and in accordance with a determination that the second application is installed on the computer system, forgoing initiation of the process to install the second application; and after installing the second application as part of the process to add the accessory device to the ecosystem and in accordance with a determination that a set of one or more automatic removal criteria is satisfied, removing the second application without detecting a user input to remove the second application.

In some embodiments, a computer program product is described. In some embodiments, the computer program product comprises one or more programs configured to be executed by one or more processors of a computer system that is in communication with one or more input devices. In some embodiments, the one or more programs include instructions for: detecting, via the one or more input devices, an input corresponding to a request to add an accessory device to an ecosystem corresponding to a first application; in response to detecting the input corresponding to the request to add the accessory device to the ecosystem, initiating a process to add the accessory device to the ecosystem, wherein the process to add the accessory device to the ecosystem includes: in accordance with a determination that a second application is not installed on the computer system, initiating a process to install the second application, wherein the second application corresponds to the accessory device, and wherein the second application is different from the first application; and in accordance with a determination that the second application is installed on the computer system, forgoing initiation of the process to install the second application; and after installing the second application as part of the process to add the accessory device to the ecosystem and in accordance with a determination that a set of one or more automatic removal criteria is satisfied, removing the second application without detecting a user input to remove the second application.

In some embodiments, a method that is performed at an electronic device is described. In some embodiments, the method comprises: pairing with an accessory device; after pairing with the accessory device, commissioning the accessory device on a first set of one or more security domains; after commissioning the accessory device on the first set of one or more security domains, sending, to the accessory device, a request to enter into a recommissioning mode; and after sending the request to enter into the recommissioning mode: receiving, from the accessory device, recommissioning data; and causing, via a resident device different from the accessory device and the electronic device, the accessory device to be recommissioned on a second set of one or more security domains using the recommissioning data, wherein the second set of one or more security domains is different from the first set of one or more security domains.

In some embodiments, a non-transitory computer-readable storage medium storing one or more programs configured to be executed by one or more processors of an electronic device is described. In some embodiments, the one or more programs includes instructions for: pairing with an accessory device; after pairing with the accessory device, commissioning the accessory device on a first set of one or more security domains; after commissioning the accessory device on the first set of one or more security domains, sending, to the accessory device, a request to enter into a recommissioning mode; and after sending the request to enter into the recommissioning mode: receiving, from the accessory device, recommissioning data; and causing, via a resident device different from the accessory device and the electronic device, the accessory device to be recommissioned on a second set of one or more security domains using the recommissioning data, wherein the second set of one or more security domains is different from the first set of one or more security domains.

In some embodiments, a transitory computer-readable storage medium storing one or more programs configured to be executed by one or more processors of an electronic device is described. In some embodiments, the one or more programs includes instructions for: pairing with an accessory device; after pairing with the accessory device, commissioning the accessory device on a first set of one or more security domains; after commissioning the accessory device on the first set of one or more security domains, sending, to the accessory device, a request to enter into a recommissioning mode; and after sending the request to enter into the recommissioning mode: receiving, from the accessory device, recommissioning data; and causing, via a resident device different from the accessory device and the electronic device, the accessory device to be recommissioned on a second set of one or more security domains using the recommissioning data, wherein the second set of one or more security domains is different from the first set of one or more security domains.

In some embodiments, an electronic device is described. In some embodiments, the electronic device comprises one or more processors and memory storing one or more programs configured to be executed by the one or more processors. In some embodiments, the one or more programs includes instructions for: pairing with an accessory device; after pairing with the accessory device, commissioning the accessory device on a first set of one or more security domains; after commissioning the accessory device on the first set of one or more security domains, sending, to the accessory device, a request to enter into a recommissioning mode; and after sending the request to enter into the recommissioning mode: receiving, from the accessory device, recommissioning data; and causing, via a resident device different from the accessory device and the electronic device, the accessory device to be recommissioned on a second set of one or more security domains using the recommissioning data, wherein the second set of one or more security domains is different from the first set of one or more security domains.

In some embodiments, an electronic device is described. In some embodiments, the electronic device comprises means for performing each of the following steps: pairing with an accessory device; after pairing with the accessory device, commissioning the accessory device on a first set of one or more security domains; after commissioning the accessory device on the first set of one or more security domains, sending, to the accessory device, a request to enter into a recommissioning mode; and after sending the request to enter into the recommissioning mode: receiving, from the accessory device, recommissioning data; and causing, via a resident device different from the accessory device and the electronic device, the accessory device to be recommissioned on a second set of one or more security domains using the recommissioning data, wherein the second set of one or more security domains is different from the first set of one or more security domains.

In some embodiments, a computer program product is described. In some embodiments, the computer program product comprises one or more programs configured to be executed by one or more processors of an electronic device. In some embodiments, the one or more programs include instructions for: pairing with an accessory device; after pairing with the accessory device, commissioning the accessory device on a first set of one or more security domains; after commissioning the accessory device on the first set of one or more security domains, sending, to the accessory device, a request to enter into a recommissioning mode; and after sending the request to enter into the recommissioning mode: receiving, from the accessory device, recommissioning data; and causing, via a resident device different from the accessory device and the electronic device, the accessory device to be recommissioned on a second set of one or more security domains using the recommissioning data, wherein the second set of one or more security domains is different from the first set of one or more security domains.

In some embodiments, a method that is performed at an electronic device is described. In some embodiments, the method comprises: receiving, from an installer device, a request to commission an accessory device, wherein the request to commission the accessory device includes connection information corresponding to the accessory device, wherein the accessory device is different from the installer device and the electronic device, and wherein the installer device is different from the electronic device; and in response to receiving the request to commission the accessory device: establishing, with the accessory device, a connection using the connection information; and commissioning, using the connection, the accessory device on a set of one or more security domains.

In some embodiments, a non-transitory computer-readable storage medium storing one or more programs configured to be executed by one or more processors of an electronic device is described. In some embodiments, the one or more programs includes instructions for: receiving, from an installer device, a request to commission an accessory device, wherein the request to commission the accessory device includes connection information corresponding to the accessory device, wherein the accessory device is different from the installer device and the electronic device, and wherein the installer device is different from the electronic device; and in response to receiving the request to commission the accessory device: establishing, with the accessory device, a connection using the connection information; and commissioning, using the connection, the accessory device on a set of one or more security domains.

In some embodiments, a transitory computer-readable storage medium storing one or more programs configured to be executed by one or more processors of an electronic device is described. In some embodiments, the one or more programs includes instructions for: receiving, from an installer device, a request to commission an accessory device, wherein the request to commission the accessory device includes connection information corresponding to the accessory device, wherein the accessory device is different from the installer device and the electronic device, and wherein the installer device is different from the electronic device; and in response to receiving the request to commission the accessory device: establishing, with the accessory device, a connection using the connection information; and commissioning, using the connection, the accessory device on a set of one or more security domains.

In some embodiments, an electronic device is described. In some embodiments, the electronic device comprises one or more processors and memory storing one or more programs configured to be executed by the one or more processors. In some embodiments, the one or more programs includes instructions for: receiving, from an installer device, a request to commission an accessory device, wherein the request to commission the accessory device includes connection information corresponding to the accessory device, wherein the accessory device is different from the installer device and the electronic device, and wherein the installer device is different from the electronic device; and in response to receiving the request to commission the accessory device: establishing, with the accessory device, a connection using the connection information; and commissioning, using the connection, the accessory device on a set of one or more security domains.

In some embodiments, an electronic device is described. In some embodiments, the electronic device comprises means for performing each of the following steps: receiving, from an installer device, a request to commission an accessory device, wherein the request to commission the accessory device includes connection information corresponding to the accessory device, wherein the accessory device is different from the installer device and the electronic device, and wherein the installer device is different from the electronic device; and in response to receiving the request to commission the accessory device: establishing, with the accessory device, a connection using the connection information; and commissioning, using the connection, the accessory device on a set of one or more security domains.

In some embodiments, a computer program product is described. In some embodiments, the computer program product comprises one or more programs configured to be executed by one or more processors of an electronic device. In some embodiments, the one or more programs include instructions for: receiving, from an installer device, a request to commission an accessory device, wherein the request to commission the accessory device includes connection information corresponding to the accessory device, wherein the accessory device is different from the installer device and the electronic device, and wherein the installer device is different from the electronic device; and in response to receiving the request to commission the accessory device: establishing, with the accessory device, a connection using the connection information; and commissioning, using the connection, the accessory device on a set of one or more security domains.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIGS. 3A-3K illustrate exemplary user interfaces for adding accessories to a home ecosystem in accordance with some embodiments.

FIG. 4 is a flow diagram illustrating a process for temporarily installing an application to add an accessory to an ecosystem in accordance with some embodiments.

FIG. 5 is a flow diagram illustrating a process for commissioning an accessory by an installer device in accordance with some embodiments.

FIG. 6 is a flow diagram illustrating a process for commissioning an accessory by a resident device in accordance with some embodiments.

FIG. 7 illustrates a process for installing a resident device and initializing a fabric in accordance with some embodiments.

FIG. 8 illustrates a process for commissioning an accessory device by an installer device in accordance with some embodiments.

FIG. 9 illustrates a process for operating a resident device in standalone mode in accordance with some embodiments.

FIG. 10 illustrates a process for enrolling a resident device in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

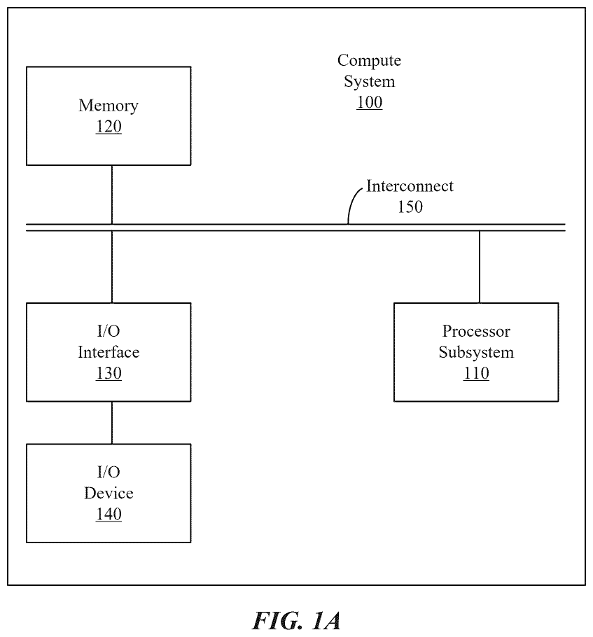

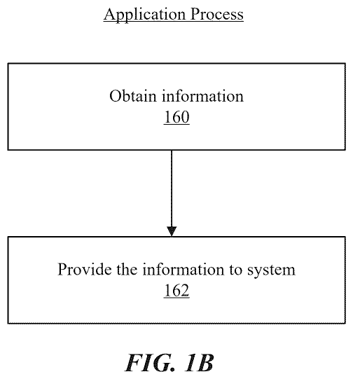

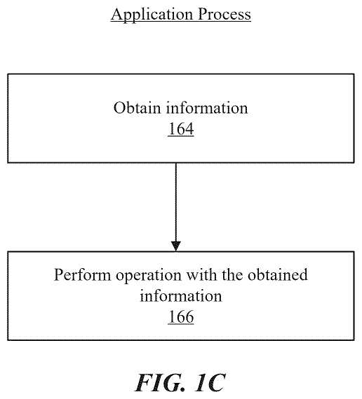

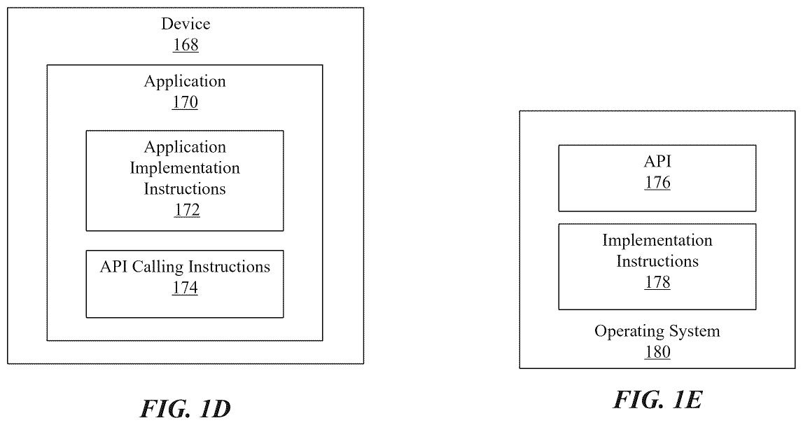

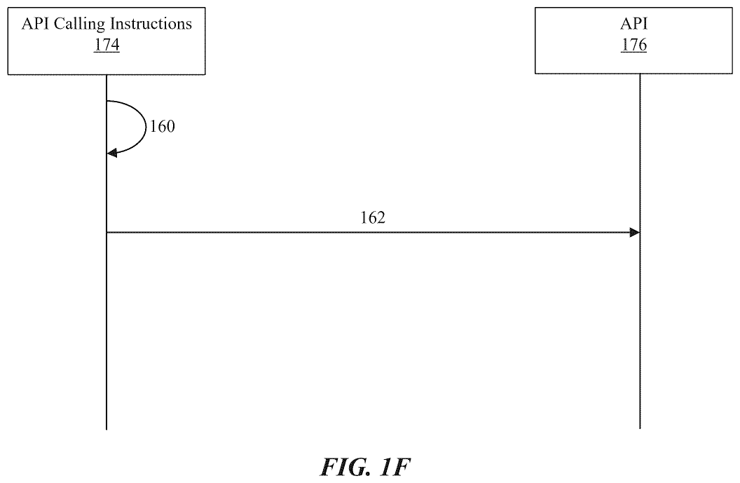

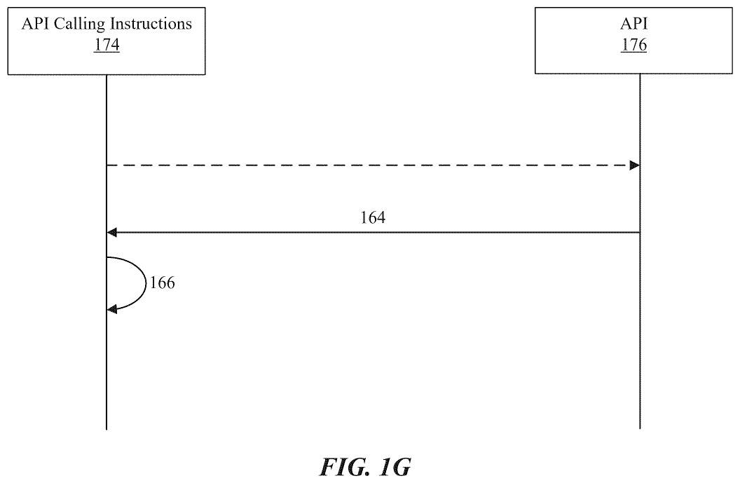

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

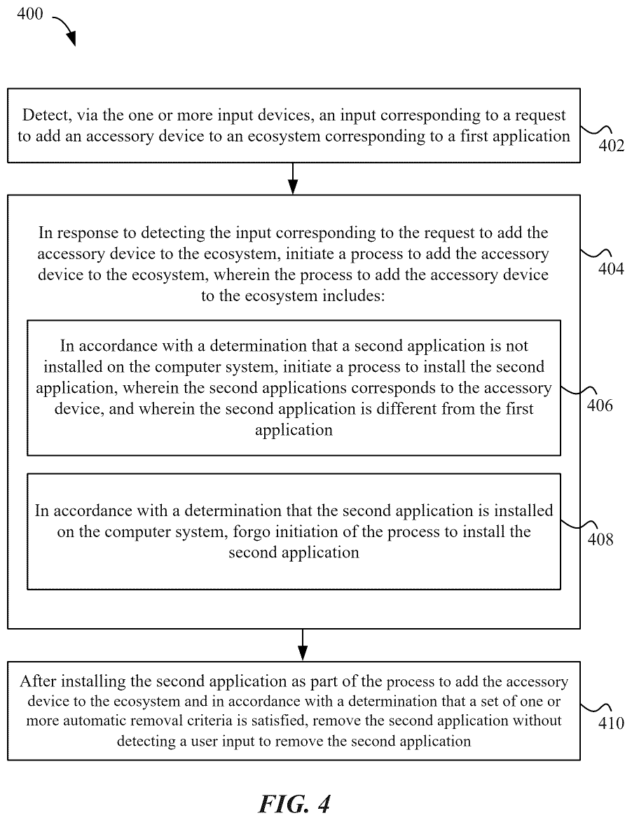

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 400, 500, and 600 (FIGS. 4, 5, and 6) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

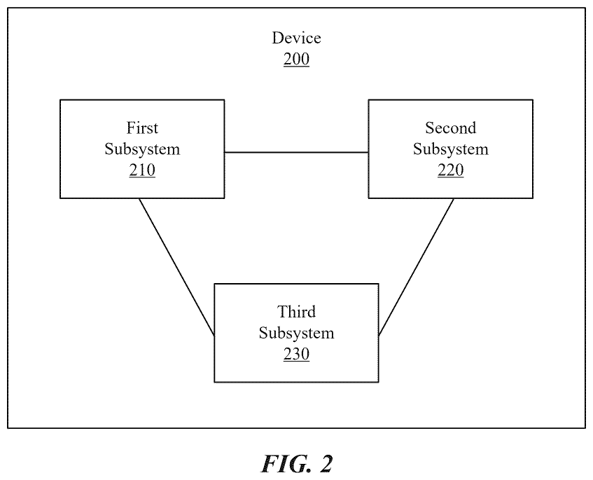

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for adding an accessory to an ecosystem. Such techniques are described in the context of a vacuum being added to a home ecosystem using a user interface flow from one or more user interfaces of a home application to one or more user interfaces of an operating system to one or more user interfaces of a vacuum application to one or more user interfaces of the home application to one or more user interfaces of a vacuum application to one or more user interfaces of the home application. It should be recognized that other user interface flows can be used with techniques described herein. For example, techniques described herein can use a user interface flow from one or more user interfaces of an operating system to one or more user interfaces of a vacuum application to one or more user interfaces of a home application. In addition, techniques optionally complement or replace other techniques for adding an accessory to an ecosystem.

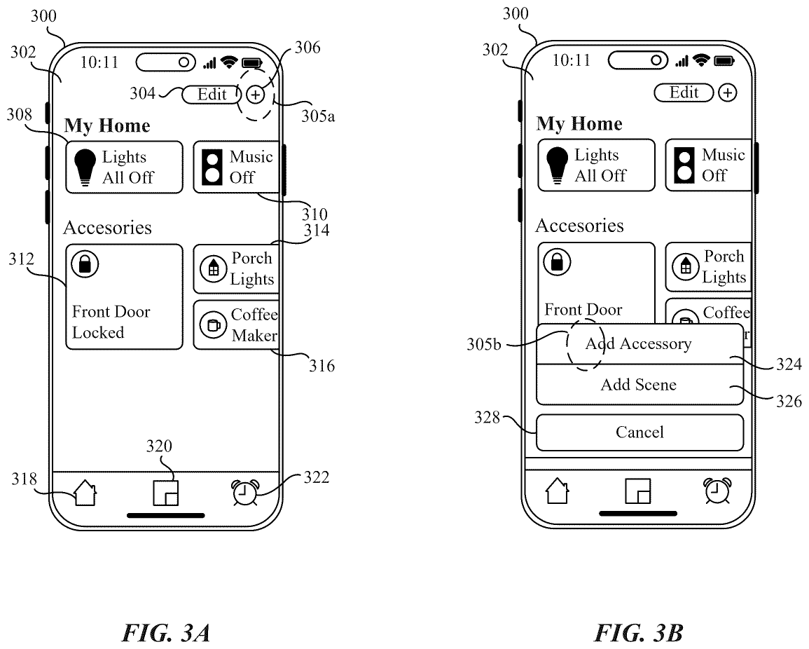

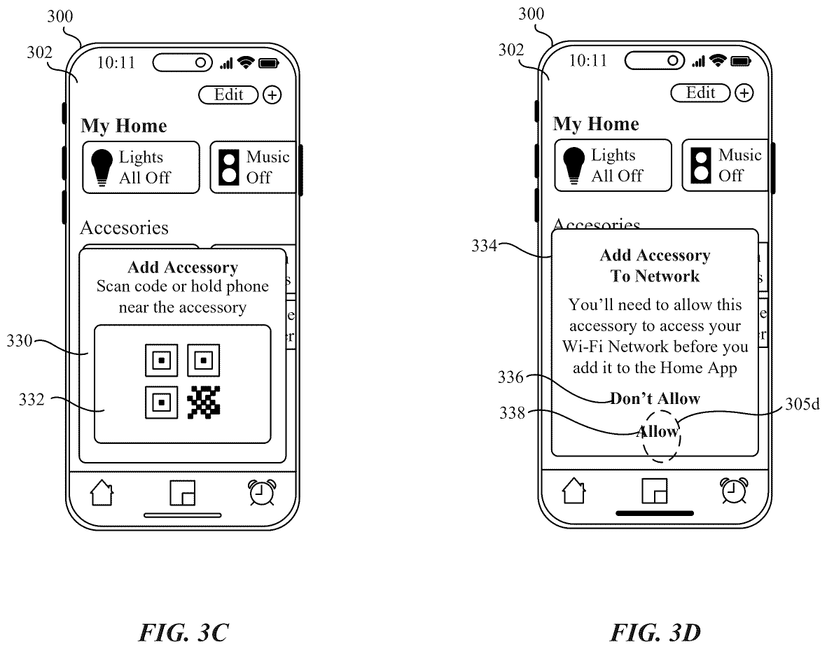

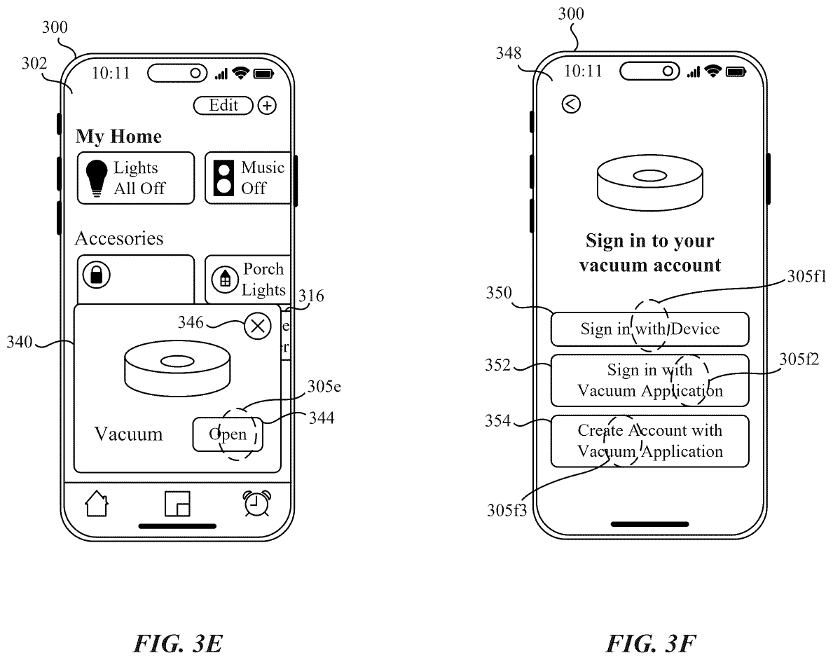

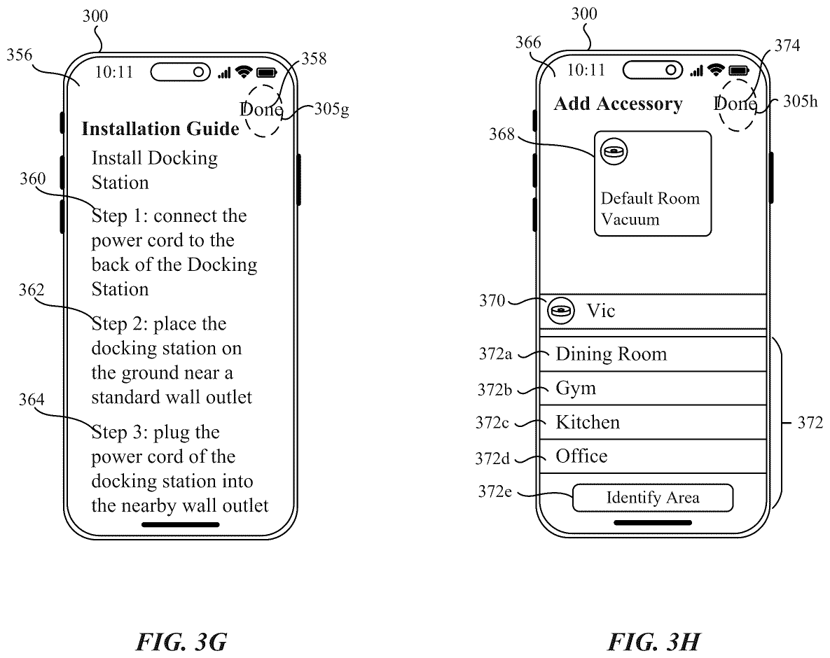

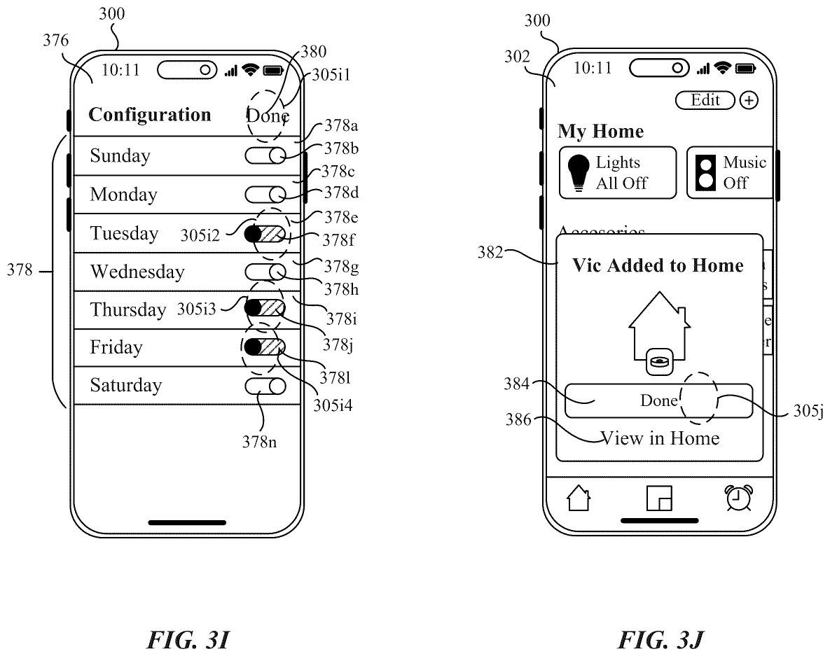

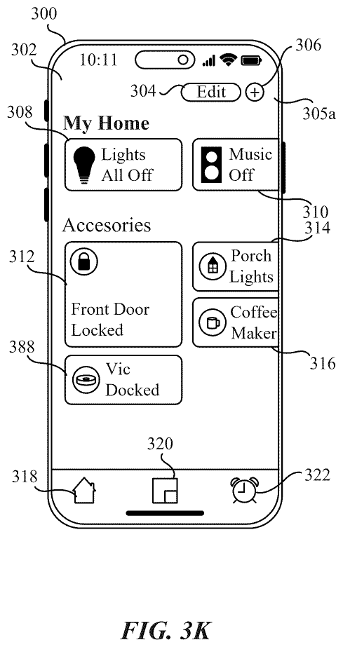

FIGS. 3A-3K illustrate exemplary user interfaces for adding accessories to a home ecosystem in accordance with some embodiments. The user interfaces in these figures are used to illustrate the processes described below, including the processes in FIGS. 4-6.

FIGS. 3A-3K illustrate computer system 300. In this example, computer system 300 is illustrated as a smart phone. It should be recognized that computer system 300 can be other types of computer systems, such as a smart watch, a tablet, a laptop, a desktop, a communal device, an accessory (sometimes referred to herein as an accessory device), a personal gaming system, a laptop computer, a fitness tracking device, and/or a head-mounted display (HMD) device.

In the examples described below with respect to FIGS. 3A-3K, computer system 300 displays user interfaces of a home application, of an operating system, and of a vacuum application. In some embodiments, the home application is an application that allows users to control, communicate with, and/or check a status of one or more accessories. In some embodiments, the operating system is software (sometimes referred to as an application) that manages hardware and/or software resources of computer system 300. In such embodiments, system processes, such as services and/or daemons, can perform operations on behalf of the operating system. In some embodiments, the vacuum application is an application of a type of accessory and/or is provided by a manufacturer of the type of accessory. In such embodiments, an accessory corresponding to the vacuum application can require use of the vacuum application (and/or some subset as described further below with respect to FIG. 3E) to add the accessory to a home ecosystem (e.g., a collection of one or more accessories that are part of a single security domain as described further below) of the home application. It should be recognized that user interfaces of one type of application described herein can be user interfaces of another type of application than described herein, including a user interface of the home application can be a user interface of the operating system and/or a user interface of the operating system can be a user interface of a camera application.

In some embodiments, computer system 300 is in communication with another computer system (sometimes referred to below as a resident device) that is different from computer system 300. In such embodiments, the resident device can be a device that is physically present in a physical area (sometimes referred to as a home) to add, commission, install, configure, manage, control, communicate with, and/or identify accessories in the home. For example, the resident device can add accessories to the home ecosystem corresponding to the home application using one or more of the processes described below with respect to FIGS. 3A-3K.

While the examples in FIGS. 3A-3K include computer system 300 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras.

As illustrated in FIG. 3A, computer system 300 displays user interface 302 of the home application. In some embodiments, user interface 302 includes representations of accessories previously added to the home ecosystem. In some embodiments, the representations of accessories allow quick access to a state, a status, and/or control of existing accessories in the home ecosystem. In some embodiments, under a “My Home” section, user interface 302 includes representations of categories of content, such as climate, lights, and/or music. In such embodiments, the categories of content can allow users to quickly control and/or access user interfaces of accessories that are part of these categories. For example, representation 308 for lights (e.g., with indication “All Off”) and representation 310 for music (e.g., with indication “Off”) provide quick access to a status of an accessory and/or control of the accessory. In some embodiments, under an “Accessories” section, user interface 302 includes representations of accessories in the home ecosystem such as representation 312 for a front door lock, representation 314 for porch lights, and representation 316 for a coffee maker. In some embodiments, instead of including a full list of all accessories in the home ecosystem, the “Accessories” section can include accessories of a specific area, zone, and/or room in the home ecosystem to which the accessories were previously added, assigned, and/or configured. For example, when a user has a preconfigured room such as a living room, the “Accessories” section can include a list of accessories corresponding to (e.g., added, assigned, and/or configured to be included in) the living room. In some embodiments, representations of accessories (e.g., 308, 310, 312, 314, and/or 316) provide statuses and/or controls of one or more accessories that they correspond to. For example, representation 312 of the front door lock can indicate that the front door is currently “Locked” or “Unlocked.” In some embodiments, representations of accessories can include one or more controls leading to other user interfaces of the home application and/or another application (e.g., an application corresponding to a type of accessory as described above) for accessing more features and/or controls of the accessories. In some embodiments, user interface 302 includes an edit button (e.g., 304) for editing, adding, and/or removing representations of accessories from user interface 302. In some embodiments, user interface 302 includes one or more user interface elements (e.g., 318, 320, and/or 322) for leading to other user interfaces of the home application such as an option for navigating to a user interface for automation (e.g., 322) and/or user interface 302 (e.g., 318). In some embodiments, user interface 302 includes an add button (e.g., 306) labeled “+”, displayed at the top right corner of user interface 302, for adding a new accessory and/or a new scene to the home ecosystem. It should be recognized that user interface 302 can include more, less, and/or different content than illustrated in FIG. 3A and that such placement of certain user interface elements is for explanatory purposes.

At FIG. 3A, computer system 300 detects tap input 305a directed to add button 306. It should be recognized that input 305a is an example of a selection input and can be other types of inputs, such as a mouse click, a verbal input, and/or a button press. It should also be recognized that, in some embodiments, description corresponding to FIG. 3B is optional and instead tap input 305a causes computer system 300 to proceed to description corresponding to FIG. 3C.

As illustrated in FIG. 3B, in response to detecting tap input 305a, computer system 300 displays a modal on top of user interface 302, such as covering a bottom portion of user interface 302. In some embodiments, the modal belongs to the home application and includes button 324 for adding an accessory labeled “Add Accessory,” button 326 for adding a scene labeled “Add Scene,” and/or button 328 for cancelling the modal labeled “Cancel.” In some embodiments, button 324 for adding an accessory is used to initiate a process for adding an accessory to the home ecosystem, which is further described below with respect to FIGS. 3C-3K. In some embodiments, button 326 for adding a scene is used to create a new scene that can control multiple accessories simultaneously. In some embodiments, button 328 for cancelling the modal allows a user to dismiss the modal without making a selection of button 324 or button 326.

At FIG. 3B, computer system 300 detects tap input 305b directed to button 324 for adding an accessory. It should be recognized that tap input 305b is an example of a selection input and can be other inputs, such as a voice input or an air gesture directed at button 324 for initiating the process for adding an accessory to the home ecosystem.

As illustrated in FIG. 3C, in response to detecting tap input 305b, computer system 300 displays user interface 330 on top of user interface 302, such as partially covering user interface 302. In other embodiments, user interface 330 replaces user interface 302. In some embodiments, user interface 330 belongs to the home application and includes camera view 332, which displays a live feed from one or more cameras that are in communication with and/or included in computer system 300. It should be recognized that user interface 330 can belong to other applications, such as the operating system or a camera application of computer system 300.

In some embodiments, camera view 332 allows a user to scan a Quick Response (QR) code associated with an accessory, such as a vacuum as used as an example in the description below. In some embodiments, the QR code associated with the accessory is displayed or printed on the accessory. In other embodiments, the QR code associated with the accessory is provided with documentation and/or a box associated with the accessory. In some embodiments, user interface 330 includes an instruction that guides a user to scan the QR code on the accessory and/or hold their device (e.g., computer system 300) near the accessory for identifying an accessory via a wireless communication as further discussed below. In such embodiments, an accessory can be identified for initiating a process to add the accessory by detecting the accessory in proximity to computer system 300. For example, computer system 300 can use NFC, Bluetooth, and/or other short-range wireless technologies to detect a presence of an accessory within a range. It should be recognized that user interface 330 is for explanatory purposes and can include more, less, and/or different content than illustrated, including different mechanisms for identifying an accessory instead of camera view 332.

At FIG. 3C, computer system 300 detects an input for identifying an accessory as a step of adding the accessory to the home ecosystem, which in this example is detection of a QR code via camera view 332. It should be recognized that the input for identifying an accessory can be other types of inputs, such as an NFC detection event and/or a Bluetooth pairing.

As illustrated in FIG. 3D, in response to detecting the input for identifying the accessory, computer system 300 displays user interface 334 for adding the accessory to one or more networks associated with the home ecosystem. In some embodiments, computer system 300 displays user interface 334 in response to and/or after computer system 300 pairs with the accessory using information obtained via the QR code. For example, the QR code can be used to obtain a pairing code, address information, and/or other identifying information for the accessory so that computer system 300 can connect (e.g., via a short range communication channel, such as Bluetooth) to the accessory. As illustrated in FIG. 3D, user interface 334 includes a prompt for informing a user that the accessory needs to be allowed access to a WiFi network before adding to the home ecosystem. It should be recognized that a WiFi network is an example of a type of network that can be used and that other types of networks can also be used, such as a Thread network and/or a cellular network.

As illustrated in FIG. 3D, user interface 334 includes two buttons: “Don't Allow” button 336 and “Allow” button 338. In some embodiments, “Don't Allow” button 336 and “Allow” button 338 give a user control over granting the accessory access to a network associated with the home ecosystem (e.g., a home Wi-Fi network). In some embodiments, if the user selects “Don't Allow” button 336, the process for adding the accessory to the home ecosystem is cancelled and/or paused until network access is granted.

At FIG. 3D, computer system 300 detects tap input 305d on “Allow” button 338. It should be recognized that tap input 305d is an example of a selection input and can be other inputs, such as an air gesture directed at the “Allow” button or a voice command to allow the accessory access to a network associated with the home ecosystem.

In some embodiments, after granting the accessory access to a network associated with the home ecosystem, computer system 300 determines whether an accessory application corresponding to the accessory has already been installed on computer system 300. In some embodiments, there are multiple versions of the accessory application that will suffice for adding the accessory to the home ecosystem. For example, there can be a full application that is installed by a user and is maintained on computer system 300 until a user determines to remove the application. For another example, there can be a lighter weight application (referred to as the vacuum application herein), corresponding to the full application, that is temporarily downloaded and/or installed such that the vacuum application is automatically removed from computer system 300 without computer system 300 detecting user input after the accessory is added to the home ecosystem. In such an example, the vacuum application can have limited functionality, be faster to download, and/or be smaller in size than the full application. The vacuum application can allow access to functionality of the full application without a need for installing the full application. In some embodiments, the vacuum application is automatically removed from computer system 300 after a setup process (e.g., as described below with respect to FIGS. 3F-3J) or after a predetermined period of use of the vacuum application has lapsed.

As illustrated in FIG. 3E, in response to detecting input 305d when the accessory application is not installed on computer system 300, computer system 300 displays user interface 340. In some embodiments, user interface 340 is provided by the operating system and allows a user to initiate a process to download, install, and/or otherwise obtain the vacuum application. In such embodiments, the operating system manages integration of user interfaces of the home application and user interfaces of the vacuum application to allow for a seamless transition between user interfaces during the process for adding the accessory to the home ecosystem. In some embodiments, the integration can involve passing relevant data (such as accessory data, user account data, and/or accessory configuration data) between the home application, the operating system, and/or the accessory application. It should be recognized that user interface 340 can be provided by other applications, such as the home application and/or a browser.

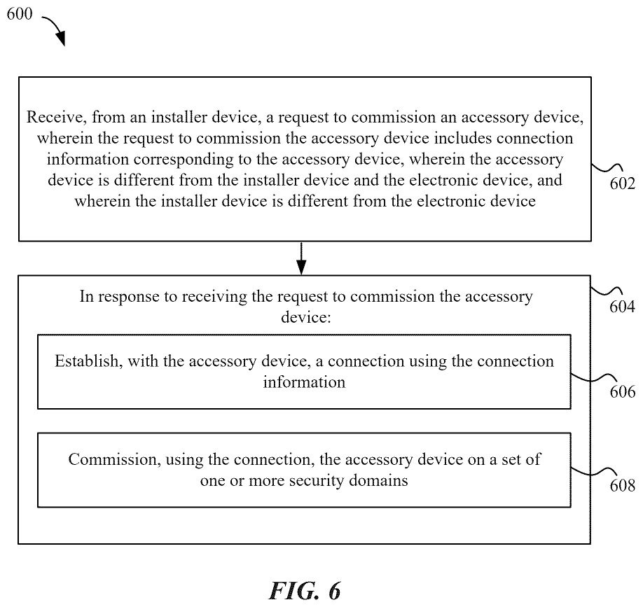

As illustrated in FIG. 3E, user interface 340 includes a representation of the accessory (e.g., an icon or image of the vacuum in this example) and a default name and/or identifier of the accessory (e.g., “Vacuum” in this example). As also illustrated in FIG. 3E, user interface 340 includes dismiss button 346, represented as an “X” in the top-right corner of user interface 340. In some embodiments, dismiss button 346 allows a user to end the process for adding the accessory to the home ecosystem. As also illustrated in FIG. 3E, user interface 340 includes button 344, labeled “Open” in this example. In some embodiments, button 344 is used to initiate the process to download, install, and/or otherwise obtain the vacuum application. It should be recognized that user interface 340 can include more, fewer, and/or different content than illustrated in FIG. 6E, such as a “Get Started” button, a “Connect” button, and/or other buttons performing different operations and/or obtaining different information. In some embodiments, the operating system customizes user interface 340 based on information received from the home application or the accessory itself. For example, user interface 340 can include a specific model of the vacuum and/or an indication of the home ecosystem being used. It should be recognized that computer system 300 can initiate the process to download, install, and/or otherwise obtain the vacuum application at other times, such as in response to detecting the input for identifying the accessory as described above with respect to FIG. 3C. In some embodiments, when obtaining the vacuum application at other times, user interface 340 can be skipped.

At FIG. 3E, computer system 300 detects tap input 305e on button 344. It should be recognized that tap input 305e is an example of a selection input and can be other types of inputs, such as a voice command or an air gesture directed at button 344.

In some embodiments, in response to detecting tap input 305e and/or obtaining the vacuum application, computer system 600 displays a user interface of the vacuum application. In such embodiments, the user interface can depend on the vacuum application and/or what type of accessory is being added. In particular, different applications and/or different accessories can have a different user interface flow that includes different user interfaces. Examples of such user interfaces can include content corresponding to installation and/or configuration of the accessory that are required and/or optional to adding the accessory to the home ecosystem. In some embodiments, some steps described as part of adding the accessory to the home ecosystem on user interfaces of the home application, such as allowing the accessory to access a network associated with the home ecosystem, can be instead provided via user interfaces of the vacuum application (e.g., such as on user interfaces illustrated in FIGS. 3E-3G or FIG. 3I). Similarly, in some embodiments, some steps described as part of adding the accessory to the home ecosystem on user interfaces of the vacuum application can be instead provided via user interfaces of the home application (such as on user interfaces illustrated in FIGS. 3A-3D, 3H, and/or 3J-3K).

As illustrated in FIG. 3F, in response to detecting tap input 305e and/or obtaining the vacuum application, computer system 300 displays user interface 348 of the vacuum application. In some embodiments, user interface 348 is a user interface for signing into the vacuum application. As illustrated in FIG. 3F, user interface 348 includes (1) a title (e.g., “Sign in to your vacuum account”), (2) a back button in the top left corner to go back to user interface 340 or user interface 302, and (3) multiple buttons (e.g., button 350, button 352 and button 354) for signing into the vacuum application, each button using a different method for signing in. It should be recognized that user interface 340 is used as an example and that some applications might use more, fewer, and/or different methods and/or might not require a user to sign in and therefore skip user interface 340 altogether.

In some embodiments, button 350 labeled “Sign in with Device” allows a user to authenticate using one or more credentials stored on and/or associated with computer system 300. For example, the one or more credentials can be for single-sign on (SSO) authentication method that is not tied only to the vacuum application and/or the home application. In some embodiments, button 352 labeled “Sign in with Vacuum Application” allows a user to sign-in with one or more credentials of the vacuum application. For example, the vacuum application (and/or an organization corresponding to the vacuum application, such as a third-party vendor, manufacturer, and/or seller of the accessory) can allow users to directly create accounts with the vacuum application that are only used for the vacuum application. In some embodiments, button 354 labeled “Create Account with Vacuum Application” provides an option for a user to create an account with the vacuum application. In such embodiments, the account created can later be signed in using, for example, button 352.

In some embodiments, a selection made at user interface 348 determines a subsequent flow of the process to add the accessory to the home ecosystem. For example, choosing to create a new account (e.g., input 305f3) can lead to additional user interfaces for entering and/or submitting user information while choosing to sign in with existing credentials (e.g., input 305f1 or input 305f2) can lead to different user interfaces for completing a sign-in process (such as through one or more user interfaces of the operating system and/or the vacuum application. In some embodiments, user interface 348 includes an option to skip authentication.

FIG. 3F illustrates computer system 300 detecting inputs 305f1, 305f3 or 305f3. It should be recognized that these inputs are examples of selection inputs and can be other types of inputs such as voice commands for authenticating or air gestures directed at the respective buttons. It should also be recognized that only one of these inputs would be detected at a time and that each input would cause a different user interface flow to be used.

As illustrated in FIG. 3G, in response to signing into the vacuum application, computer system 300 displays user interface 356 of the vacuum application. In some embodiments, user interface 356 is an installation guide for setting up physical components of the vacuum such as a docking station. As illustrated in FIG. 3G, user interface 356 includes button 358 labeled “done”, for completing and/or moving forward with the third-party setup process of the accessory.

At FIG. 3G, computer system 300 detects tap input 305g on button 358. It should be recognized that tap input 305g is an example of a selection input and can be other inputs, such as a voice command to confirm completion of physical installation or an air gesture directed at button 358.

As illustrated in FIG. 3H, in response to detecting tap input 305g on button 358, computer system 300 displays user interface 366 of the home application. In some embodiments, user interface 366 is a configuration user interface for configuring a name of the vacuum and in which group that the vacuum should be a part of (e.g., dining room, gym, kitchen, or office).

As illustrated in FIG. 3H, user interface 366 includes representation 368 of the vacuum with pre-defined and/or placeholder values (e.g., name and/or group assignment) for the vacuum. In some embodiments, user interface 366 includes input field 370 for naming the vacuum. For example, as illustrated in FIG. 3H, the user entered “Vic” as a name for the vacuum that will replace the default name (such as “Vacuum”) on representations of the vacuum in the home application. In some embodiments, user interface 366 includes areas and/or rooms that were pre-configured on the home application. For example, user interface 366 displays options 372 of preconfigured areas and/or rooms in the home ecosystem such as a gym (e.g., represented by option 372b) and/or a dining room (e.g., represented by option 372a). In such an example, the preconfigured areas and/or rooms are used to group accessories so that such preconfigured areas and/or rooms can be used to show particular sets of accessories. As illustrated in FIG. 3H, user interface 366 includes button 372 labeled “Identify area”. In some embodiments, selection of button 372 causes computer system 300 to display one or more user interfaces for identifying and/or adding a new area and/or room that was not pre-configured for the home ecosystem.

As illustrated in FIG. 6H, user interface 366 includes button 374 labeled “Done” at the top right corner of user interface 366 that allows a user to save configuration selections (e.g., name of vacuum and/or area assignments) and proceed with the process of adding the vacuum to the home ecosystem. It should be recognized that user interface 366 can include more, fewer, and/or different configuration options, such as setting up features of the vacuum, configuring automation rules, and/or linking the vacuum with other accessories and/or devices. In some embodiments, the other configuration options can be based on existing data in the home application about the home ecosystem and/or based on specific features and/or capabilities of the vacuum. In some embodiments, configuration options can be displayed on additional user interfaces different from user interface 366.

At FIG. 3H, computer system 300 detects tap input 305h on the button 374. It should be recognized that tap input 305h is an example of a selection input and can be other inputs, such as a voice command to confirm configuration selections or an air gesture directed at button 374.

As illustrated in FIG. 3I, after completing configuration selections for adding the vacuum to the home ecosystem, computer system 300 displays user interface 376 of the vacuum application. In some embodiments, this transition back to the vacuum application occurs after determining that additional configuration steps are available on the vacuum application. It should be recognized that user interface 376 is used as an example and that it can occur before or after user interface 366 in the process for adding the vacuum to the home ecosystem.

In some embodiments, user interface 376 is a user interface for configuring features of the accessory, such as a cleaning schedule of the vacuum. As illustrated in FIG. 3I, user interface 376 includes a view of days of the week with selectable toggles (e.g., 378a-378l) for each day for allowing a user to set a weekly cleaning schedule for the vacuum. At FIG. 3I, a user has unselected Tuesday (e.g., via input 305i2 on toggle 378f), Thursday (e.g., via input 305i3 on toggle 378j) and Friday (e.g., via input 305i4 on toggle 378l), thereby selecting the other four days of the week for the vacuum to perform cleaning in areas and/or rooms of the house that the vacuum is configured with.

As illustrated in FIG. 3I, user interface 376 includes a button 380 labeled “Done” at the top right corner of user interface 376 to save configuration selections, such as the cleaning schedule described with respect to FIG. 3I. In some embodiments, data associated with configuration selections submitted on user interface 376 is saved within the vacuum application. In some embodiments, the data associated with configuration selections is sent to the home application to be integrated into the process for adding the vacuum to the home ecosystem. In other embodiments, the data is not shared with the home application. It should be noted that while the example described herein showcases a cleaning schedule configuration, the vacuum application can include other configuration options, such as setting cleaning modes, adjusting power, and/or integrating with other devices. In some embodiments, these other configuration options can be displayed across additional user interfaces of the vacuum application different from user interface 376. In some embodiments, the accessory application can customize configuration options based on information received from the home application about the user's home ecosystem and/or based on the capabilities of the vacuum.

At FIG. 3I, computer system 300 detects tap input 305i1 on button 380. It should be recognized that tap input 305i1 is an example of a selection input and can be other inputs, such as a voice command to save configuration selections or an air gesture directed at button 380.

As illustrated in FIG. 3J, in response to detecting tap input 605i1, computer system 300 ceases display of user interface 376 and displays user interface 302 of the home application (e.g., after detecting completion of the process to add the vacuum to the home ecosystem). In some embodiments, user interface 302 displays confirmation user interface 382 with a message indicating successful addition of the vacuum to the home ecosystem. In this example, the message reads “Vic Added to Home” confirming that the vacuum (e.g., named “Vic” by a user in a previous configuration step as described with respect to FIG. 3H) has been successfully added to the home ecosystem. In some embodiments, confirmation user interface 382 includes button 384 labeled “Done” that allows a user to acknowledge completion of the process of adding the vacuum to the home ecosystem and return to user interface 302 of the home application. Additionally, in some embodiments, button 386 labeled “View in Home” is displayed. In response to detecting an input directed to control 386, computer system 300 displays a detailed view of the vacuum in the home application. In some embodiments, confirmation user interface 382 can also include a summary of configuration selections, such as area and/or room assignments and/or cleaning schedule of the vacuum. At this stage, in some embodiments, data associated with configurations set via the home application and/or the vacuum application are now synchronized with the operating system of computer system 300 and/or with other devices in the home ecosystem. It should be recognized that, while confirmation user interface 382 is illustrated on top of user interface 302, confirmation user interface 382 can be displayed on top of whatever user interface was displayed when initiating the process to add the vacuum to the home ecosystem. For example, if the process to add the vacuum to the home ecosystem was initiated from a user interface of a camera application by scanning a QR code, confirmation user interface 382 can be displayed on top of the user interface of the camera application and selection of button 384 can return to the user interface of the camera application.

At FIG. 3J, computer system 300 detects tap input 305j on button 384. It should be recognized that tap input 305j is an example of a selection input and can be other inputs, such as a voice input of acknowledgement or an air gesture directed at button 384.

As illustrated in FIG. 3K, after and/or in response to detecting tap input 305j on button 384, computer system 300 re-displays user interface 302 of the home application, such as by dismissing confirmation user interface 382. In some embodiments, user interface 302 now includes representation 388 of the vacuum that was just added to the home ecosystem. In some embodiments, representation 388 of the vacuum is added under an area and/or room that the accessory was assigned to.

In some embodiments, representation 388 displays “Vic” as a name for the vacuum (e.g., which was assigned to the vacuum during the configuration process, as described with respect to FIG. 3H). In some embodiments, representation 388 includes status indicators and/or controls of the vacuum. As illustrated in FIG. 3K, representation 388 includes a current status of the vacuum (e.g., “Docked”). In some embodiments, in response to detecting an input corresponding to representation 388, computer system 300 can perform one or more operations with respect to the vacuum. For example, tapping on representation 388 can start a cleaning cycle, pause an ongoing cleaning, and/or send the vacuum to its docking station.

In some embodiments, the description above with respect to FIGS. 3A-3K applied to one or more processes described below. For example, process 500 describes a process for an electronic device to commission an accessory device on a first set of one or more security domains. It should be recognized that a security domain of the first set of one or more security domains can be the home ecosystem and that the description above with respect to FIGS. 3A-3K can be used to commission the accessory device on the first set of one or more security domains.

FIG. 4 is a flow diagram illustrating a process (e.g., process 400) for temporarily installing an application to add an accessory to an ecosystem in accordance with some embodiments. Some operations in process 400 are, optionally, combined, the orders of some operations are, optionally, changed, and some operations are, optionally, omitted.

As described below, process 400 provides an intuitive way for temporarily installing an application to add an accessory to an ecosystem. Process 400 reduces the cognitive burden on a user, thereby creating a more efficient human-machine interface. For battery-operated computing devices, enabling a user to interact with such devices faster and more efficiently conserves power and increases the time between battery charges.

In some embodiments, process 400 is performed at a computer system (e.g., 300) (e.g., an electronic device a resident device, a computer system, a user device, a commissioning device, and/or a controller device) that is in communication with (and/or includes) one or more input devices (e.g., a wireless radio, a port, a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the electronic device is a watch, a phone, a tablet, a fitness tracking device, a processor, a head-mounted display (HMD) device, a communal device, a media device, a speaker, a television, and/or a personal computing device.

The computer system detects (402), via the one or more input devices, an input (e.g., 305a, 305b, and/or an input as described with respect to FIG. 3C) corresponding to a request to add an accessory device (e.g., an accessory device as described with respect to and/or as illustrated in FIGS. 3C-3K) (e.g., a device configured to be controlled by one or more other devices) to an ecosystem (e.g., an ecosystem as described with respect to FIG. 3A and/or FIG. 3K) (e.g., a software framework that manages and/or controls one or more devices and/or computer systems) corresponding to (and/or of) a first application (e.g., corresponding to 302) (e.g., of the computer system). In some embodiments, the input is a message, a tap input, and/or an indication of presence and/or proximity of the accessory device. In some embodiments, the ecosystem corresponds to a security domain (e.g., as described below with respect to process 400 and/or CS2). In some embodiments, after adding the accessory device to the ecosystem, the computer system is able to obtain a status of and/or control the accessory device via the ecosystem and/or the first application. In some embodiments, the first application is downloaded and/or installed on the computer system. In some embodiments, the accessory device is a display, a television, a light, a lock, a security system, a speaker, an appliance, and/or a thermostat.

In response to detecting the input corresponding to the request to add the accessory device to the ecosystem, the computer system initiates (404) a process (e.g., a process as described with respect to and/or illustrated in FIGS. 3C-3J) to add the accessory device to the ecosystem, wherein the process to add the accessory device to the ecosystem includes: (406) in accordance with a determination that a second application (e.g., corresponding to 340, 348, 346, and/or 376) is not installed (and/or downloaded) on the computer system, initiating a process to install (and/or download) the second application, wherein the second application corresponds to the accessory device, and wherein the second application is different from the first application; and in accordance with (408) a determination that the second application is installed (and/or downloaded) on the computer system, forgoing (e.g., as described above with respect to FIG. 3E) initiation of the process to install (and/or download) the second application. In some embodiments, the process to install (and/or download) the second application includes displaying one or more user interfaces to download and/or install the second application. In some embodiments, the process to install (and/or download) the second application does not include displaying the one or more user interfaces to download and/or install the second application. In some embodiments, the process to install (and/or download) the second application includes obtaining permission from a user of the computer system to download and/or install the second application. In some embodiments, the process to add the accessory device to the ecosystem includes configuring the accessory device to communicate via a network, such as an Internet network, a cellular network, a wired network, a wireless network, a WiFi network, and/or a Thread network. In some embodiments, the process to add the accessory device to the ecosystem includes configuring the accessory device with a name and/or an area in which the accessory device is located.

After installing the second application as part of the process to add the accessory device to the ecosystem and in accordance with a determination that a set of one or more automatic removal criteria is satisfied (e.g., an amount of time has expired since installing and/or interacting with the second application), the computer system removes (410) (e.g., uninstalls, deletes, automatically removes, and/or otherwise gets rid of) (e.g., as described above with respect to FIG. 3E) the second application (e.g., from being installed on the computer system) without detecting a user input to remove the second application. In some embodiments, after installing the second application as part of the process to add the accessory device to the ecosystem and in accordance with a determination that the set of one or more automatic removal criteria is not satisfied, the computer system maintains installation of the second application on the computer system. In some embodiments, after adding the accessory device to the ecosystem and in accordance with a determination that the second application was installed and/or downloaded outside of the process to add the accessory device to the ecosystem, the computer system does not remove the second application unless the computer system receives a user input to remove the second application.

In some embodiments, the computer system is in communication with (and/or includes) one or more display generation components (e.g., a display screen, a projector, a head mounted display, and/or a touch-sensitive display). In some embodiments, in response to installing the second application (and/or as part of the process to add the accessory device to the ecosystem), the computer system displays, via the one or more display generation components, a user interface (e.g., 348) of the second application. In some embodiments, the user interface of the second application includes a user interface element for logging into an account of the second application. In some embodiments, the user interface of the second application includes a user interface element for creating an account of the second application. In some embodiments, the user interface of the second application includes a user interface element for configuring the accessory device (e.g., information and/or one or more settings corresponding to the accessory device).

In some embodiments, the computer system is in communication with (and/or includes) one or more display generation components (e.g., a display screen, a projector, a head mounted display, and/or a touch-sensitive display). In some embodiments, the input is detected while displaying, via the one or more display generation components, a user interface of a third application (e.g., a camera application, an operating system, and/or other application as described above with respect to FIG. 3C) different from the second application (e.g., without displaying a user interface of the second application and/or a user interface of the first application).

In some embodiments, the third application is part of an operating system (e.g., as described above with respect to FIG. 3C) of the computer system. In some embodiments, the third application is a system process of the operating system.

In some embodiments, the third application (e.g., corresponding to 302) is the first application.

In some embodiments, the accessory device is a first accessory device. In some embodiments, after detecting the input corresponding to the request to add the first accessory device to the ecosystem of the first application, the computer system detects, via the one or more input devices, an input corresponding to a request to add a second accessory device (e.g., an accessory device as described with respect to and/or as illustrated in FIGS. 3C-3K) (e.g., a device configured to be controlled by one or more other devices) to the ecosystem corresponding to the first application, wherein the second accessory device is different from the first accessory device. In some embodiments, the input corresponding to the request to add the second accessory device is a message, a tap input, and/or an indication of presence and/or proximity of the second accessory device. In some embodiments, after adding the second accessory device to the ecosystem, the computer system is able to obtain a status of and/or control the second accessory device via the ecosystem and/or the first application (e.g., as described with respect to FIG. 3K). In some embodiments, the second accessory device is a display, a television, a light, a lock, a security system, a speaker, an appliance, and/or a thermostat. In some embodiments, in response to detecting the input corresponding to the request to add the second accessory device to the ecosystem, the computer system initiates a process to add the second accessory device to the ecosystem (e.g., a process as described with respect to and/or illustrated in FIGS. 3C-3J), wherein the process to add the second accessory device to the ecosystem includes: in accordance with a determination that a fourth application (e.g., as described about with respect to different applications for different accessories using a similar process as described for the vacuum) is not installed (and/or downloaded) on the computer system, initiating a process to install (and/or download) the fourth application (e.g., while the second application is installed on the computer system or while the second application is not installed on the computer system), wherein the fourth applications corresponds to the second accessory device, and wherein the fourth application is different from the first application and the second application (and/or the third application); and in accordance with a determination that the fourth application is installed (and/or downloaded) on the computer system, forgoing initiation (e.g., as described about with respect to different applications for different accessories using a similar process as described for the vacuum) of the process to install (and/or download) the second application. In some embodiments, the process to install (and/or download) the fourth application includes displaying one or more user interfaces to download and/or install the fourth application. In some embodiments, the process to install (and/or download) the fourth application does not include displaying the one or more user interfaces to download and/or install the fourth application. In some embodiments, the process to install (and/or download) the fourth application includes obtaining permission from a user of the computer system to download and/or install the fourth application. In some embodiments, the fourth application is unrelated to the second application. In some embodiments, the fourth application is not associated with the second application. In some embodiments, the fourth application is specific to an organization that is separate from an organization that is specific to the second application. In some embodiments, the process to add the second accessory device to the ecosystem includes configuring the second accessory device to communicate via the network. In some embodiments, the process to add the second accessory device to the ecosystem includes configuring the second accessory device with a name and/or an area in which the second accessory device is located. In some embodiments, after installing the fourth application as part of the process to add the second accessory device to the ecosystem and in accordance with a determination that the set of one or more automatic removal criteria is satisfied (e.g., an amount of time has expired since installing and/or interacting with the fourth application), the computer system removes (e.g., uninstalls, deletes, automatically removes, and/or otherwise gets rid of) (e.g., as described about with respect to different applications for different accessories using a similar process as described for the vacuum) the fourth application without detecting a user input to remove the fourth application. In some embodiments, after installing the fourth application as part of the process to add the second accessory device to the ecosystem and in accordance with a determination that the set of one or more automatic removal criteria is not satisfied, the computer system maintains installation of the fourth application on the computer system. In some embodiments, after adding the second accessory device to the ecosystem and in accordance with a determination that the fourth application was installed and/or downloaded outside of the process to add the second accessory device to the ecosystem, the computer system does not remove the fourth application unless the computer system receives a user input to remove the fourth application.

In some embodiments, the computer system is in communication with (and/or includes) one or more display generation components (e.g., a display screen, a projector, a head mounted display, and/or a touch-sensitive display). In some embodiments, the input corresponding to the request to add the accessory device to the ecosystem is detected while displaying, via the one or more display generation components, a user interface (e.g., 330). In some embodiments, in response to detecting the accessory device in proximity to the computer system, the computer system displays, via the one or more display generation components, the user interface. In some embodiments, the accessory device is detected in proximity to the computer system via a wireless communication. In some embodiments, the accessory device is detected in proximity to the computer system via a near-field communication (NFC). In some embodiments, the accessory device is detected in proximity to the computer system via ultra-wideband (UWB) communication. In some embodiments, the input corresponding to the request to add the accessory device to the ecosystem is a determination that the accessory device is in proximity to the computer system (e.g., as described with respect to FIG. 3C).

In some embodiments, the computer system is in communication with (and/or includes) one or more display generation components (e.g., a display screen, a projector, a head mounted display, and/or a touch-sensitive display). In some embodiments, the input corresponding to the request to add the accessory device to the ecosystem is detected while displaying, via the one or more display generation components, a user interface (e.g., 330). In some embodiments, in response to scanning a Quick Response (QR) code (e.g., as described with respect to and/or illustrated in FIG. 3C), the computer system displays, via the one or more display generation components, the user interface. In some embodiments, the input corresponding to the request to add the accessory device to the ecosystem is scanning the QR code (e.g., as described with respect to and/or illustrated in FIG. 3C).

In some embodiments, the process to add the accessory device to the ecosystem includes: connecting (and/or causes connection of) the accessory device to a network (e.g., as described with respect to FIG. 3D) (e.g., an Internet network, a cellular network, a wired network, a wireless network, a WiFi network, and/or a Thread network). In some embodiments, the accessory device is connected to the network via a user interface (e.g., 334) of the first application. In some embodiments, the accessory device is connected to the network via a user interface of the second application. In some embodiments, the accessory device is connected to the network via a user interface of the third application.

In some embodiments, before removing the second application, the second application is not added to a list of applications installed on the computer system after installing the second application as part of the process to add the accessory device to the ecosystem (e.g., the second application is installed but not added to the list of applications installed on the computer system) (e.g., as described with respect to FIG. 3E).

In some embodiments, the second application is installed without entering a credential (e.g., a password, a passkey, and/or biometric information). In some embodiments, the computer system detects, via the one or more inputs devices, an input (e.g., a tap input and/or a voice request) corresponding to a request to install (and/or download) a fifth application (e.g., a full application as described above with respect to FIG. 3E) different from the first application and the second application (and/or the third application and/or the fourth application), wherein the fifth application corresponds to (and/or is associated with) the second application. In some embodiments, the fifth application and the second application have overlapping functionality. In some embodiments, the fifth application is a portion of the second application. In some embodiments, the fifth application is a temporary application of the second application (e.g., as described with respect to FIG. 3E). In some embodiments, the second application is a non-temporary application of the fifth application. In some embodiments, in response to detecting the input corresponding to the request to install the fifth application, the computer system requests (and/or requires) one or more credentials (e.g., a password, a passkey, and/or biometric information) to be provided to allow the fifth application to be installed (e.g., as sometimes required to install a full application as opposed to a lighter weight application). In some embodiments, requesting one or more credentials to be provided to allow the fifth application to be installed includes displaying an authentication user interface to authenticate a user.

In some embodiments, the computer system is in communication with (and/or includes) one or more display generation components (e.g., a display screen, a projector, a head mounted display, and/or a touch-sensitive display). In some embodiments, after (and/or in response to) adding the accessory device to the ecosystem, the computer system displays, via the one or more display generation components, a user interface (e.g., 302) of the first application (and/or the ecosystem), wherein the user interface includes a current status (e.g., of 388 and/or as described with respect to and/or illustrated in FIG. 3K) (e.g., a state, such as on, off, and/or a power level) of the accessory device. In some embodiments, the current status of the accessory device is obtained by the computer system communicating with the accessory device.

In some embodiments, the user interface of the first application includes a control (e.g., a control in 388 and/or as described with respect to FIG. 3K) (e.g., a virtual button, slider, and/or other type of user interface element that is able to be used to change a state of the accessory device) corresponding to the accessory device. In some embodiments, while displaying the user interface of the first application and the control corresponding to the accessory device, the computer system detects, via the one or more input devices, an input (e.g., a tap input, a selection input, and/or a movement input) corresponding to the control (e.g., an input as described with respect to FIG. 3K). In some embodiments, in response to detecting the input corresponding to the control, the computer system changes a state of the accessory device in accordance with (and/or based on) the input corresponding to the control. In some embodiments, changing the state of the accessory device in accordance with the input corresponding to the control includes turning the accessory device on or off.

In some embodiments, the process to add the accessory device to the ecosystem includes: in accordance with a determination that the second application is not logged into at least one account, automatically creating, using a credential (e.g., username and/or password) of (e.g., stored on, associated with, corresponding to, and/or accessible by) the computer system, an account with the second application. In some embodiments, the account is created without detecting an input corresponding to selection of the credential. In some embodiments, in response to automatically creating the account with the second application, the computer system logs into the account for the second application without detecting user input.

In some embodiments, the computer system is in communication with (and/or includes) one or more display generation components (e.g., a display screen, a projector, a head mounted display, and/or a touch-sensitive display). In some embodiments, the process to add the accessory device to the ecosystem includes concurrently displaying, via the one or more display generation components (e.g., as described with respect to and/or illustrated in FIG. 3F): a first option (e.g., 350) to log into the second application using a credential (e.g., username and/or password) of (e.g., stored on, associated with, corresponding to, and/or accessible by) the computer system; and In some embodiments, in response to detecting, via the one or more input devices, an input (e.g., a tap input and/or a voice request) corresponding to the first option, the computer system automatically creates an account for the second application using the credential of the computer system. In some embodiments, the account for the second application is created without detecting an input corresponding to selection of the credential. a second option (e.g., 352), separate from the first option, to log into an account of the second application. In some embodiments, in response to detecting, via the one or more input devices, an input (e.g., a tap input and/or a voice request) corresponding to the second option, the computer system displays, via the one or more display generation components, one or more text entry fields for entering a username and/or a password for an account of the second application. In some embodiments, after entering the username and/or the password, the computer system logs into an account using the username and/or the password. In some embodiments, the process to add the accessory device to the ecosystem includes displaying, via the one or more display generation components, a third option, separate from the first option and the second option, to create an account for the second application (e.g., while displaying the first option and/or the second option or without displaying the first option and/or the second option).

In some embodiments, the process to add the accessory device to the ecosystem includes: detecting, via the one or more input devices, an input (e.g., an input corresponding to 370, 372a, 372b, 372c, or 372d) (e.g., typed input, a tap input, and/or a voice request) corresponding to a request to assign an attribute (e.g., a name and/or a location) to the accessory device; and in response to detecting the input corresponding to the request to assign the attribute (e.g., an attribute corresponding to 368, 370, 372a-e, and/or 388) to the accessory device, assigning the attribute to the accessory device such that the attribute affects display of content corresponding to the accessory device (e.g., the name represents the accessory device in one or more user interfaces and/or the location groups the accessory device with one or more other accessory devices in the location) (e.g., as described with respect to and/or illustrated in FIG. 3H and/or FIG. 3K).

In some embodiments, the attribute (e.g., an attribute corresponding to 368, 370, 372a-e, and/or 388) is assigned to the accessory device via the first application (e.g., and not via the second application).

In some embodiments, the attribute (e.g., an attribute corresponding to 368, 370, 372a-e, and/or 388) is assigned to the accessory device via the second application (e.g., and not via the first application) (e.g., as described with respect to FIG. 3G).

In some embodiments, the computer system is in communication with (and/or includes) one or more display generation components (e.g., a display screen, a projector, a head mounted display, and/or a touch-sensitive display). In some embodiments, the process to add the accessory device to the ecosystem includes displaying, via the one or more display generation components, a user interface (e.g., 302, 366, or 382) of the first application. In some embodiments, the user interface of the first application includes a user interface element (e.g., 350) for logging into an account of the first application. In some embodiments, the user interface of the first application includes a user interface element for creating an account of the first application. In some embodiments, the user interface of the first application includes a user interface element for configuring the accessory device (e.g., information and/or one or more settings corresponding to the accessory device).

In some embodiments, the user interface of the first application is displayed before initiating the process to install the second application (e.g., as described with respect to and/or illustrated in FIGS. 3A-3B).

In some embodiments, the user interface of the first application is displayed after initiating the process to install the second application (and/or after installing the second application and/or after displaying one or more user interfaces of the second application) (e.g., as described with respect to and/or illustrated in FIGS. 3C-3E, FIG. 3H, and/or FIGS. 3J-3K).

Note that details of the processes described above with respect to process 400 (e.g., FIG. 4) are also applicable in an analogous manner to other processes described herein. For example, process 500 optionally includes one or more of the characteristics of the various processes described above with reference to process 400. For example, the commissioning of process 500 can include adding the accessory device to the ecosystem of process 400. For brevity, these details are not repeated herein.

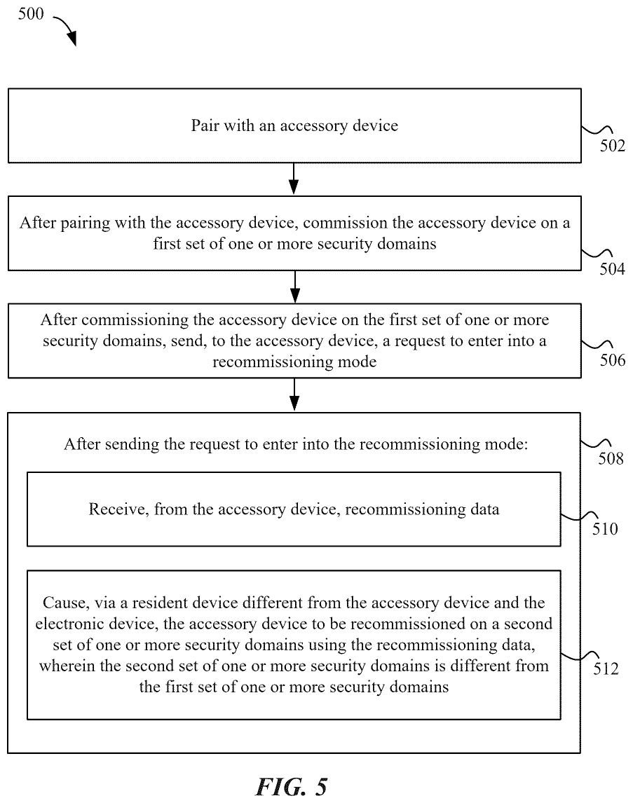

FIG. 5 is a flow diagram illustrating a process (e.g., process 500) for commissioning an accessory by an installer device in accordance with some embodiments. Some operations in process 500 are, optionally, combined, the orders of some operations are, optionally, changed, and some operations are, optionally, omitted.

As described below, process 500 provides an intuitive way for commissioning an accessory by an installer device. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at an electronic device (e.g., computer system 300) (e.g., an installer device, an installation device, a computer system, a user device, a commissioning device, and/or a controller device). In some embodiments, the electronic device is a watch, a phone, a tablet, a fitness tracking device, a processor, a head-mounted display (HMD) device, a communal device, a media device, a speaker, a television, and/or a personal computing device.

The electronic device pairs (502) (e.g., as described with respect to FIGS. 3C-3D) with an accessory device (e.g., an accessory device as described with respect to and/or as illustrated in FIGS. 3C-3K) (e.g., a device configured to be controlled by one or more other devices). In some embodiments, pairing with the accessory device (e.g., as described with respect to FIG. 3E) includes establishing a connection and/or exchanging information, such as information used to communicate, information used to communicate privately, and/or information to validate communications from each device. In some embodiments, pairing with the accessory device includes registering the electronic device with the accessory device and/or the accessory device with the electronic device. In some embodiments, before pairing with the accessory device, the accessory device advertises itself. In such embodiments, the electronic device detects the accessory device advertising and, in response and/or after, initiates a pairing process with the accessory device. In some embodiments, pairing with the accessory device includes establishing one or more keys to be used for communicating between the electronic device and the accessory device. In some embodiments, the accessory device is a display, a television, a light, a lock, a security system, a speaker, an appliance, and/or a thermostat.

After pairing with the accessory device (and/or while communicating with or while not communicating with the accessory device), the electronic device commissions (504) (e.g., provisions, adds, registers, and/or establishes) the accessory device on a first set of one or more security domains (e.g., as described with respect to and/or illustrated in FIGS. 3J-3K) (e.g., fabrics, secure communication networks, and/or groups). In some embodiments, commissioning the accessory device on the first set of one or more security domains includes registering the accessory device on the first set of one or more security domains (e.g., each security domain included in the first set of one or more security domains). In some embodiments, commissioning the accessory device on the first set of one or more security domains includes configuring the accessory device to communicate (e.g., with the electronic device and/or one or more other devices) using a network (sometimes referred to as an operational network), such as an Internet network, a cellular network, a wired network, a wireless network, a WiFi network, and/or a Thread network. In other embodiments, before commissioning the accessory device on the first set of one or more security domains, the electronic devices configure the accessory device to communicate using the network. In some embodiments, the electronic device, after commissioning, communicates with the accessory device using the network. In some embodiments, commissioning the accessory device on the first set of one or more security domains includes discovering the accessory device on the network and establishing a connection with the accessory device. In other embodiments, before commissioning the accessory device on the first set of one or more security domains, the electronic devices discover the accessory device on the network and establishes the connection with the accessory device. In some embodiments, commissioning the accessory device on a single security domain includes providing, to the accessory device, one or more credentials to be used by the accessory device to communicate with other devices in the single security domain. In some embodiments, the first set of one or more security domains includes an installer domain (e.g., a temporary domain used to recommission the accessory device to another security domain), an administrative domain (e.g., a domain that is used to coordinate addition of other security domains), and/or one or more ecosystem-specific domains (e.g., a domain specific to an application and/or a company). In some embodiments, the first set of one or more security domains corresponds to, is administered by, is controlled by, is associated with, and/or is owned by the electronic device.

After commissioning the accessory device on the first set of one or more security domains, the electronic device sends (506), to the accessory device (e.g., via one or more networks that the accessory device gained access while commissioning the accessory device on the first set of one or more security domains), a request to enter into a recommissioning mode (and/or a commissioning mode). In some embodiments, the accessory device is in the commissioning mode when the electronic device commissions the accessory device on the first set of one or more security domains.

After (508) sending the request to enter into the recommissioning mode (and/or while the accessory device is in the recommissioning mode or the commissioning mode), the electronic device receives (510), from the accessory device, recommissioning data. In some embodiments, the recommissioning data includes a code (e.g., a pairing code and/or a commissioning code, such as an Enhanced Commissioning Method (ECM) code) used by a device to commission the accessory device on one or more security domains. In some embodiments, the code used to recommission is different from a code used to commission.

After (508) sending the request to enter into the recommissioning mode, the electronic device causes (512), via a resident device (e.g., an electronic device, a computer system, a user device, a commissioning device, and/or a controller device) different from the accessory device and the electronic device, the accessory device to be recommissioned on a second set of one or more security domains using the recommissioning data, wherein the second set of one or more security domains is different from the first set of one or more security domains. In some embodiments, the resident device, the accessory device, and/or the electronic device communicate via a single network or multiple networks. In some embodiments, the resident device is not commissioned on the first set of one or more security domains while causing the accessory device to be recommissioned on the second set of one or more security domains. In some embodiments, the first set of one or more security domains includes at least one security domain included in the second set of one or more security domains. In some embodiments, the first set of one or more security domains includes at least one security domain not included in the second set of one or more security domains. In some embodiments, the second set of one or more security domains includes at least one security domain not included in the first set of one or more security domains. In some embodiments, the first set of one or more security domains does not include a security domain included in the second set of one or more security domains. In some embodiments, the second set of one or more security domains does not include a security domain included in the first set of one or more security domains. In some embodiments, causing the accessory device to be recommissioned on the second set of one or more security domains using the recommissioning data includes sending, to the resident device, the recommissioning data. In some embodiments, the recommissioning data is sent from the resident device to the accessory device as part of and/or to recommission the accessory device. In some embodiments, the resident device is an electronic device and/or computer system that is on a network in a home that includes the accessory device. In some embodiments, the resident device is a watch, a phone, a tablet, a fitness tracking device, a processor, a head-mounted display (HMD) device, a communal device, a media device, a speaker, a television, and/or a personal computing device. In some embodiments, the electronic device and the accessory device communicate with each other via the resident device. In some embodiments, the second set of one or more security domains corresponds to, is administered by, is controlled by, is associated with, and/or is owned by the resident device (e.g., and not the electronic device).

In some embodiments, before causing, via the resident device, the accessory device to be recommissioned on the second set of one or more security domains, the electronic device connects to a network (e.g., an operational network, an Internet network, a cellular network, a wired network, a wireless network, a WiFi network, and/or a Thread network). In some embodiments, while connected to the network, the electronic device obtains, via the network an address of the resident device. In some embodiments, the address is an Internet Protocol (IP) address. In some embodiments, after obtaining the address of the resident device (and/or while connected to the network), the electronic device connects, using the address (e.g., via the network), to a local server (and/or a port) of the resident device (e.g., establishes, using the address, a TCP connection with the local server), wherein the electronic device communicates with the resident device via the local server (and/or the port) to cause the accessory device to be recommissioned on the second set of one or more security domains. In some embodiments, causing the accessory device to be recommissioned on the second set of one or more security domains includes sending, via the local server, the recommissioning data to the resident device. In some embodiments, instead of connecting to the local server, the electronic device sends, using the address, the recommissioning data to the resident device.

In some embodiments, before pairing with the accessory device, the electronic device receives, from the resident device, connection information (e.g., network information, one or more credentials, an address, a local server address, an IP address, WiFi information, Bluetooth information, software enabled access point (SoftAP) information, and/or Thread information), wherein the electronic device communicates with the accessory device to commission the accessory device on the first set of one or more security domains using the connection information. In some embodiments, the connection information is for communicating with (e.g., sending a message to, establishing a connection with, and/or establishing a communication channel with) the resident device. In some embodiments, the connection information is for communicating with (e.g., sending a message to, establishing a connection with, and/or establishing a communication channel with) the accessory device. In some embodiments, the connection information is for communicating via one or more networks, such as an Internet network, a cellular network, a wired network, a wireless network, a WiFi network, and/or a Thread network. In some embodiments, commissioning the accessory device on the first set of one or more security domains includes communicating, using the connection information as an address (e.g., of the resident device), data to commission the accessory device. In some embodiments, commissioning the accessory device on the first set of one or more security domains includes establishing, using the connection information as an address, a connection (e.g., to a network, the resident device, and/or the accessory device) to commission the accessory device. In some embodiments, the connection information is received via a wireless communication (e.g., a short range wireless communication (e.g., NFC and/or Bluetooth) and/or a long range wireless communication) from the resident device. In some embodiments, the connection information is received by scanning a QR code (e.g., a physical QR code or a digital QR code) of the resident device. In some embodiments, the electronic device communicates with the accessory device to recommission the accessory device on the second set of one or more security domains using the connection information. In some embodiments, the electronic device communicates with the resident device to recommission the accessory device on the second set of one or more security domains using the connection information.

In some embodiments, after commissioning the accessory device on the first set of one or more security domains, the electronic device changes, using the connection information (e.g., via a communication channel established using the connection information or via sending a command to an address included in the connection information), a state of the accessory device (and/or controls, using the connection information, the accessory device) (e.g., as described with respect to FIG. 3K). In some embodiments, the state of the accessory device is changed in response to the electronic device detecting, via one or more input components (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) of the electronic device, an input corresponding to a request to change the state of the accessory device. In some embodiments, the input, corresponding to the request to change the state of the accessory device, includes a tap input on a control being displayed by the electronic device. In some embodiments, the input, corresponding to the request to change the state of the accessory device, includes a verbal request to change the state of the accessory device.

In some embodiments, after pairing with the accessory device, the electronic device receives, from the resident device, connection information (e.g., network information, one or more credentials, an address, a local server address, an IP address, WiFi information, Bluetooth information, software enabled access point (SoftAP) information, and/or Thread information) (e.g., as described above with respect to FIG. 3D), wherein the electronic device communicates with the accessory device to recommission the accessory device on the second set of one or more security domains using the connection information. In some embodiments, the electronic device communicates, using the connection information, with the resident device to cause the accessory device to be recommissioned on the second set of one or more security domains. In some embodiments, the connection information is for communicating with (e.g., sending a message to, establishing a connection with, and/or establishing a communication channel with) the resident device. In some embodiments, the connection information is for communicating with (e.g., sending a message to, establishing a connection with, and/or establishing a communication channel with) the accessory device. In some embodiments, the connection information is for communicating via one or more networks, such as an Internet network, a cellular network, a wired network, a wireless network, a WiFi network, and/or a Thread network. In some embodiments, causing the accessory device to be recommissioned on the first set of one or more security domains includes communicating, using the connection information as an address (e.g., of the resident device), data (e.g., the recommissioning data) to recommission the accessory device. In some embodiments, causing the accessory device to be recommissioned on the first set of one or more security domains includes establishing, using the connection information as an address, a connection (e.g., to a network, the resident device, and/or the accessory device) to recommission the accessory device. In some embodiments, the connection information is received via a wireless communication (e.g., a short-range wireless communication (e.g., NFC and/or Bluetooth) and/or a long-range wireless communication) from the resident device. In some embodiments, the connection information is received by scanning a QR code (e.g., a physical QR code or a digital QR code) of the resident device.

In some embodiments, after commissioning the accessory device on the first set of one or more security domains, the electronic device changes, using connection information (e.g., via a communication channel established using the connection information or via sending a command to an address included in the connection information) (e.g., a WiFi network as described with respect to FIG. 3D) obtained during the commissioning, a state of the accessory device (and/or controls, using the connection information, the accessory device). In some embodiments, the state of the accessory device is changed in response to the electronic device detecting, via one or more input components (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) of the electronic device, an input corresponding to a request to change the state of the accessory device. In some embodiments, the input, corresponding to the request to change the state of the accessory device, includes a tap input on a control being displayed by the electronic device. In some embodiments, the input, corresponding to the request to change the state of the accessory device, includes a verbal request to change the state of the accessory device.

In some embodiments, pairing with the accessory device includes scanning, via one or more cameras of the electronic device, a machine-readable code (e.g., a Quick Response code or a barcode) (e.g., as described with respect to FIG. 3C between 300 and the vacuum). In some embodiments, the machine-readable code is scanned to obtain connection information and/or one or more credentials to be used to pair with the accessory device.

In some embodiments, pairing with the accessory device includes communicating, via a wireless communication (e.g., near-field communication (NFC) and/or Bluetooth beaconing) with the accessory device (e.g., as described with respect to FIG. 3C).

In some embodiments, commissioning the accessory device (e.g., as described with respect to and/or as illustrated in FIGS. 3A-3K) on the first set of one or more security domains includes communicating, via a wireless communication (e.g., a network communication, a Bluetooth communication, a WiFi communication, a Thread communication, NFC and/or Bluetooth beaconing) (e.g., as described above with respect to FIG. 3D), with the accessory device. In some embodiments, commissioning the accessory device on the first set of one or more security domains includes communicating, via the wireless communication or another wireless communication different from the wireless communication, with the resident device.

In some embodiments, before causing the accessory device to be recommissioned on the second set of one or more security domains (and/or before pairing with the accessory device), the electronic device receives, from the resident device, a list of pre-configured groups of accessory devices (e.g., a list of rooms and/or zones). In some embodiments, after receiving the list of pre-configured groups of accessory devices and as a part of commissioning the accessory device on the first set of one or more security domains, the electronic device configures the accessory device to be included in a group of the list of preconfigured groups of accessory devices.

In some embodiments, before causing the accessory device to be recommissioned on the second set of one or more security domains (and/or before pairing with the accessory device), the electronic device receives, from the resident device, a list of pre-configured groups of accessory devices (e.g., a list of rooms and/or zones). In some embodiments, after receiving the list of pre-configured groups of accessory devices and as a part of commissioning the accessory device on the first set of one or more security domains, the electronic device configures the accessory device to be included in a group that is not included in the list of preconfigured groups of accessory devices. In some embodiments, the group is generated, identified, and/or configured by the electronic device. In some embodiments, the accessory device is configured to be included in the group in response to the electronic device detecting, via one or more input components (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) of the electronic device, an input corresponding to a request to configure the accessory device to be included in the group that is not included in the list of preconfigured groups of accessory devices. In some embodiments, the input, corresponding to the request to configure the accessory device to be included in the group that is not included in the list of preconfigured groups of accessory devices, includes a tap input on a control being displayed by the electronic device. In some embodiments, the input, corresponding to the request to configure the accessory device to be included in the group that is not included in the list of preconfigured groups of accessory devices, includes a verbal request to add the accessory device to the group.

In some embodiments, causing the accessory device to be recommissioned on the second set of one or more security domains includes sending, to the resident device, a request to recommission the accessory device. In some embodiments, the request to recommission the accessory device includes an identification (and/or indication) of the group.

In some embodiments, after (and/or in response to) causing the accessory device to be recommissioned on the second set of one or more security domains (and/or without detecting user input corresponding to a request to remove access), the electronic device removes access to the accessory device by the electronic device (e.g., after removing access to the accessory device, the electronic device is no longer able to obtain a status of the accessory device and/or control the accessory device). In some embodiments, access to the accessory device is removed without detecting user input. In some embodiments, access to the accessory device is removed in response to detecting user input corresponding to a request to remove access to the accessory device.

In some embodiments, the recommissioning data includes a commissioning code that is used to validate the resident device to the accessory device when recommissioning the accessory device. In some embodiments, the commissioning code is received by the electronic device from the accessory device.

In some embodiments, after commissioning the accessory device on the first set of one or more security domains and before causing the accessory device to be recommissioning on the second set of one or more security domains, the electronic device establishes (e.g., via the resident device) an automation with the accessory device such that the accessory device is configured to perform one or more operations (e.g., turn on at a particular time, turn off at a particular, change states at a particular time, and/or change states in response to detecting a particular event) according to the automation. In some embodiments, the automation is maintained after causing the accessory device to be recommissioning on the second set of one or more security domains. In some embodiments, the automation is established in response to detecting, via one or more input components (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) of the electronic device, an input corresponding to a request to establish the automation with the accessory device. In some embodiments, the input, corresponding to the request to establish the automation with the accessory device, includes a tap input on a control being displayed by the electronic device. In some embodiments, the input, corresponding to the request to establish the automation with the accessory device, includes a verbal request to establish the automation with the accessory device.

In some embodiments, the electronic device is a first electronic device. In some embodiments, the electronic device pairs (e.g., before, after, and/or while pairing and/or paired with the first accessory device) with a second accessory device (e.g., a device configured to be controlled by one or more other devices), wherein the second accessory device is separate (and/or different) from the first accessory device and the resident device. In some embodiments, pairing with the second accessory device includes establishing a connection and/or exchanging information, such as information used to communicate, information used to communicate privately, and/or information to validate communications from each device. In some embodiments, pairing with the second accessory device includes registering the electronic device with the second accessory device and/or the second accessory device with the electronic device. In some embodiments, before pairing with the second accessory device, the second accessory device advertises itself. In such embodiments, the electronic device detects the second accessory device advertising and, in response and/or after, initiates a pairing process with the second accessory device. In some embodiments, pairing with the second accessory device includes establishing one or more keys to be used for communicating between the electronic device and the second accessory device. In some embodiments, the second accessory device is a display, a television, a light, a lock, a security system, a speaker, an appliance, and/or a thermostat. In some embodiments, after pairing with the second accessory device (and/or while communicating with or while not communicating with the second accessory device), the electronic device commissions (e.g., provisions, adds, registers, and/or establishes) the second accessory device on a third set of one or more security domains (e.g., fabrics, secure communication networks, and/or groups) different from the first set of one or more security domains. In some embodiments, commissioning the second accessory device on the third set of one or more security domains includes registering the second accessory device on the third set of one or more security domains (e.g., each security domain included in the third set of one or more security domains). In some embodiments, commissioning the second accessory device on the third set of one or more security domains includes configuring the second accessory device to communicate (e.g., with the electronic device and/or one or more other devices) using the network. In other embodiments, before commissioning the second accessory device on the third set of one or more security domains, the electronic device configures the second accessory device to communicate using the network. In some embodiments, the electronic device, after commissioning, communicates with the second accessory device using the network. In some embodiments, commissioning the second accessory device on the third set of one or more security domains includes discovering the second accessory device on the network and establishing a connection with the second accessory device. In other embodiments, before commissioning the second accessory device on the third set of one or more security domains, the electronic device discovers the second accessory device on the network and establishes the connection with the second accessory device. In some embodiments, commissioning the second accessory device on a single security domain includes providing, to the second accessory device, one or more credentials to be used by the second accessory device to communicate with other devices in the single security domain. In some embodiments, the third set of one or more security domains includes an installer domain (e.g., a temporary domain used to recommission the second accessory device to another security domain), an administrative domain (e.g., a domain that is used to coordinate addition of other security domains), and/or one or more ecosystem-specific domains (e.g., a domain specific to an application and/or a company). In some embodiments, the third set of one or more security domains corresponds to, is administered by, is controlled by, is associated with, and/or is owned by the electronic device. In some embodiments, the third set of one or more security domains includes at least one security domain of the first set of one or more security domains. In some embodiments, the first set of one or more security domains includes at least one security domain of the third set of one or more security domains. In some embodiments, the third set of one or more security domains does not include a security domain of the first set of one or more security domains. In some embodiments, the first set of one or more security domains does not include a security domain of the third set of one or more security domains. In some embodiments, the third set of one or more security domains is determined based on a type of accessory device that the second accessory device is. In some embodiments, the first set of one or more security domains is determined based on a type of accessory device that the first accessory device is. In some embodiments, after pairing with the second accessory device (and/or while communicating with or while not communicating with the second accessory device), the electronic device, in accordance with a determination that the second accessory device is a first type (e.g., a light, a fan, a camera, a power monitor, a type of accessory device determined to relate to security, a type of accessory device determined to not relate to security, a type of accessory device determined to relate to power usage, and/or a type of accessory device determined to not relate to power usage), commissions (e.g., provisions, adds, registers, and/or establishes) the second accessory device on the first set of one or more security domains. In some embodiments, after pairing with the second accessory device (and/or while communicating with or while not communicating with the second accessory device), the electronic device, in accordance with a determination that the second accessory device is a second type (e.g., a light, a fan, a camera, a power monitor, a type of accessory device determined to relate to security, a type of accessory device determined to not relate to security, a type of accessory device determined to relate to power usage, and/or a type of accessory device determined to not relate to power usage), commissions (e.g., provisions, adds, registers, and/or establishes) the second accessory device on the third set of one or more security domains. In some embodiments, the second type is different from the first type. In some embodiments, after commissioning the second accessory device on the third set of one or more security domains, the electronic device sends, to the second accessory device (e.g., via one or more networks that the second accessory device gained access while commissioning the second accessory device on the third set of one or more security domains), a request to enter into a recommissioning mode (and/or a commissioning mode); and In some embodiments, the second accessory device is in the commissioning mode when the electronic device commissions the second accessory device on the third set of one or more security domains. In some embodiments, the recommissioning data is first recommissioning data. In some embodiments, after sending, to the second accessory device, the request to enter into the recommissioning mode (and/or while the second accessory device is in the recommissioning mode or the commissioning mode), the electronic device receives, from the second accessory device, second recommissioning data (e.g., the same as or different from the first recommissioning data). In some embodiments, the second recommissioning data includes a code (e.g., a pairing code and/or a commissioning code, such as an Enhanced Commissioning Method (ECM) code) used by a device to commission the second accessory device on one or more security domains. In some embodiments, the code used to recommission is different from a code used to commission. In some embodiments, after sending, to the second accessory device, the request to enter into the recommissioning mode (and/or while the second accessory device is in the recommissioning mode or the commissioning mode), the electronic device causes, via the resident device, the second accessory device to be recommissioned on the second set of one or more security domains using the second recommissioning data. In some embodiments, the resident device, the second accessory device, and/or the electronic device communicate via a single network or multiple networks. In some embodiments, the resident device is not commissioned on the third set of one or more security domains while causing the second accessory device to be recommissioned on the second set of one or more security domains. In some embodiments, the third set of one or more security domains includes at least one security domain included in the second set of one or more security domains. In some embodiments, the third set of one or more security domains includes at least one security domain not included in the second set of one or more security domains. In some embodiments, the second set of one or more security domains includes at least one security domain not included in the third set of one or more security domains. In some embodiments, the third set of one or more security domains does not include a security domain included in the second set of one or more security domains. In some embodiments, the second set of one or more security domains does not include a security domain included in the third set of one or more security domains. In some embodiments, causing the second accessory device to be recommissioned on the second set of one or more security domains using the second recommissioning data includes sending, to the resident device, the second recommissioning data. In some embodiments, the second recommissioning data is sent from the resident device to the second accessory device as part of and/or to recommission the second accessory device. In some embodiments, the electronic device and the second accessory device communicate with each other via the resident device.

In some embodiments, the second set of one or more security domains include multiple security domains. In some embodiments, the multiple security domains include a first security domain and a second security domain different from the first security domain. In some embodiments, the first security domain uses a first set of one or more credentials for communicating. In some embodiments, the second security domain uses a second set of one or more credentials communicating. In some embodiments, the second set of one or more credentials is different from the first set of one or more credentials. In some embodiments, the first set of one or more security domain consists of a single security domain. In some embodiments, the first set of one or more security domains include multiple security domains, each with a different set of one or more credentials.

In some embodiments, commissioning the accessory device on the first set of one or more security domains includes naming the accessory device (e.g., assigns a default or custom name to the accessory device) (e.g., as described with respect to FIG. 3H). In some embodiments, naming the accessory device includes detecting, via one or more input components (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) of the electronic device, an input includes (1) a name for the accessory device and/or (2) a request for assigning the name to the accessory device. In some embodiments, the input, including the name for the accessory device, includes typed input and/or a verbal input detected by the electronic device (e.g., as described with respect to FIG. 3H).

Note that details of the processes described above with respect to process 500 (e.g., FIG. 5) are also applicable in an analogous manner to other processes described herein. For example, process 600 optionally includes one or more of the characteristics of the various processes described above with reference to process 500. For example, the electronic device of process 500 can be the installer device of process 600. For brevity, these details are not repeated herein.

FIG. 6 is a flow diagram illustrating a process (e.g., process 600) for commissioning an accessory by a resident device in accordance with some embodiments. Some operations in process 600 are, optionally, combined, the orders of some operations are, optionally, changed, and some operations are, optionally, omitted.

As described below, process 600 provides an intuitive way for commissioning an accessory by a resident device. Process 600 reduces the cognitive burden on a user, thereby creating a more efficient human-machine interface. For battery-operated computing devices, enabling a user to interact with such devices faster and more efficiently conserves power and increases the time between battery charges.

In some embodiments, process 600 is performed at an electronic device (e.g., a resident device, a computer system, a user device, a commissioning device, and/or a controller device). In some embodiments, the electronic device is a watch, a phone, a tablet, a fitness tracking device, a processor, a head-mounted display (HMD) device, a communal device, a media device, a speaker, a television, and/or a personal computing device.

The electronic device receives (602), from an installer device (e.g., an installation device, an electronic device, a computer system, a user device, a commissioning device, and/or a controller device) (e.g., 300), a request to commission an accessory device (e.g., an accessory device as described with respect to and/or as illustrated in FIGS. 3C-3K) (e.g., a device configured to be controlled by one or more other devices), wherein the request to commission the accessory device includes connection information (e.g., a code, a credential, an identifier, a name, and/or address information) corresponding to the accessory device, wherein the accessory device is different from the installer device and the electronic device, and wherein the installer device is different from the electronic device. In some embodiments, the accessory device is a display, a television, a light, a lock, a security system, a speaker, an appliance, and/or a thermostat. In some embodiments, the request to commission the accessory device is sent as a part of causing the accessory device to be recommissioned on the second set of one or more security domains using the recommissioning data as described above with respect to process 500. In some embodiments, the accessory device is commissioned on one or more security domains (e.g., as described above with respect to the first set of one or more security domains of process 500) while the electronic device receives the request to commission the accessory device.

In response to (604) receiving the request to commission the accessory device, the electronic device establishes (606), with the accessory device, a connection using the connection information (and/or communicates with the accessory device). In some embodiments, the connection is established via a network (sometimes referred to as an operational network) that includes the accessory device and the electronic device. In some embodiments, the accessory device and the electronic device are on the network before receiving the request to commission the accessory device. In some embodiments, the network includes an Internet network, a cellular network, a wired network, a wireless network, a WiFi network, and/or a Thread network. In some embodiments, establishing the connection using the connection information includes identifying, using the connection information, the accessory device on the network and/or communicating, via the network, with the accessory device.

In response to (604) receiving the request to commission the accessory device, the electronic device commissions (608) (e.g., provisions, adds, registers, and/or establishes), using the connection, the accessory device on a set of one or more security domains (e.g., fabrics, secure communication networks, and/or groups). In some embodiments, commissioning the accessory device on the set of one or more security domains includes registering the accessory device on the set of one or more security domains (e.g., each security domain included in the set of one or more security domains). In some embodiments, the electronic device, after commissioning, communicates with the accessory device using the network. In some embodiments, commissioning the accessory device on a single security domain includes providing, to the accessory device, one or more credentials to be used by the accessory device to communicate with other devices in the single security domain. In some embodiments, the set of one or more security domains includes an administrative domain (e.g., a domain that is used to coordinate addition of other security domains) and/or one or more ecosystem-specific domains (e.g., a domain specific to an application and/or a company). In some embodiments, the set of one or more security domains corresponds to, is administered by, is controlled by, is associated with, and/or is owned by the electronic device.

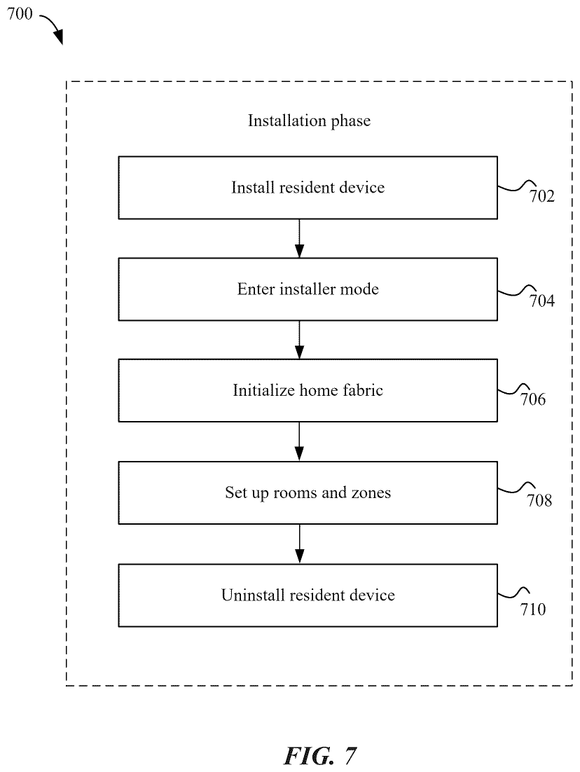

FIGS. 7-10 illustrate exemplary processes for configuring and managing a home accessory ecosystem in accordance with some embodiments. The processes in these figures are used to illustrate the processes described above, including the processes in FIGS. 5 and 6.

In some embodiments, the processes of FIGS. 7-10 enable a move-in-ready home ecosystem by pre-configuring fabrics and commissioning accessory devices on the fabrics without requiring a homeowner to individually install and/or or configure the accessory devices. In such embodiments, a fabric can represents a security domain, such as a collection of one or more configurations including a set of accessory device configurations, network infrastructure, and/or communication protocols that can be used for controlling accessory devices. For example, a fabric can maintain a set of credentials to validate communication between devices (e.g., an installer device, a resident device, and/or an accessory device), such as exchange of keys, certificates, and/or other security data, for secure communication between devices and the fabric.

FIG. 7 illustrates a diagram of an exemplary process for an installation phase of a home accessory ecosystem in accordance with some embodiments. It should be recognized that, while process 700 is described as a series of discrete steps, one or more steps of process 700 can be omitted, performed in a different order, combined, and/or further subdivided. Process 700 includes use of a device referred to as a resident device. In some embodiments, the resident device is a device that manages and/or coordinates the home accessory ecosystem for an environment, such as a home, an office, and/or a defined space. In such embodiments, the resident device can serve as a central hub for the home accessory ecosystem, acting as a router and providing a user interface for controlling accessory devices. In some embodiments, the resident device is capable of direct control of accessory devices, executing automations, and/or processing user commands for controlling the accessory devices while other devices are required to use the resident device for such operations. Examples of the resident device include a motorized smart display, a wall-mounted smart display, a control panel, a networked appliance, a multi-protocol bridge device, an accessory device, a media player, and/or a home management system.

Process 700 begins with installing (702) the resident device. In some embodiments, installing the resident device includes physically placing the resident device in a central and/or accessible location within the environment and/or connecting the resident device to power. In some embodiments, installing the resident device includes mounting the resident device on a mount, such as a wall mount, a motorized mount with wheels, and/or a robotic base. In some embodiments, installing the resident device includes assembling multiple components of the resident device, such as attaching a display screen to a base unit and/or connecting modular parts of the resident device. In some embodiments, installing the resident device includes connecting the resident device to one or more networks, such as a local network, a Thread network, a WiFi network, and/or a wired network. In some embodiments, installing the resident device includes establishing one or more networks, such as a local network, a Thread network, a WiFi network, and/or a Bluetooth network. For example, after connecting to the one or more networks (such as a WiFi network as an example), the resident device can create a new network (such as a Thread network as an example) that allows Thread-enabled accessory devices to communicate with the resident device and/or with each other. In such an example, the resident device (e.g., as a Thread border router) can facilitate communication between the Thread-enabled accessory devices and one or more controller devices using other network protocols, such as Wi-Fi, to allow a controller device to interact with the Thread-enabled accessory devices even if the controller device does not support Thread. It should be recognized that Thread is just one example of a network protocol used by the resident device and that other network protocols can be used, such as Bluetooth, WiFi, cellular, and/or a wired connection. It should also be recognized that the resident device can communicate with different accessory devices with different network protocols depending on a capability of the different accessory devices.

In some embodiments, as part of installing the resident device or after installing the resident device, the resident device establishes a local server. In some embodiments, the local server (1) is a software component running directly on the resident device and (2) provides services and/or enables communication with the resident device. In other embodiments, the local server is implemented as a web server that handles TCP connections such as HTTP requests. In some embodiments, communication with the local server happens within physical boundaries of a local area network of a home, such that any device attempting to communicate with the local server must be physically present and connected to the same local area network as the resident device. In some embodiments, the local server provides security benefits by ensuring that installation and/or commissioning processes cannot be accessed or interfered with from outside one or more local networks. In some embodiments, the local server provides a standardized way for many types of installer devices to interact with the resident device without requiring specific operating systems and/or user accounts.

After installing the resident device, process 700 includes entering (704) an installer mode on the resident device. In some embodiments, the installer mode allows an installer device (e.g., a device to initially configure one or more accessory devices, the device being a personal device of a person) and/or the resident device to set up the home accessory ecosystem and/or interact with the resident device. In such embodiments, the installer device can pair with the resident device to enter into or as part of the installer mode.

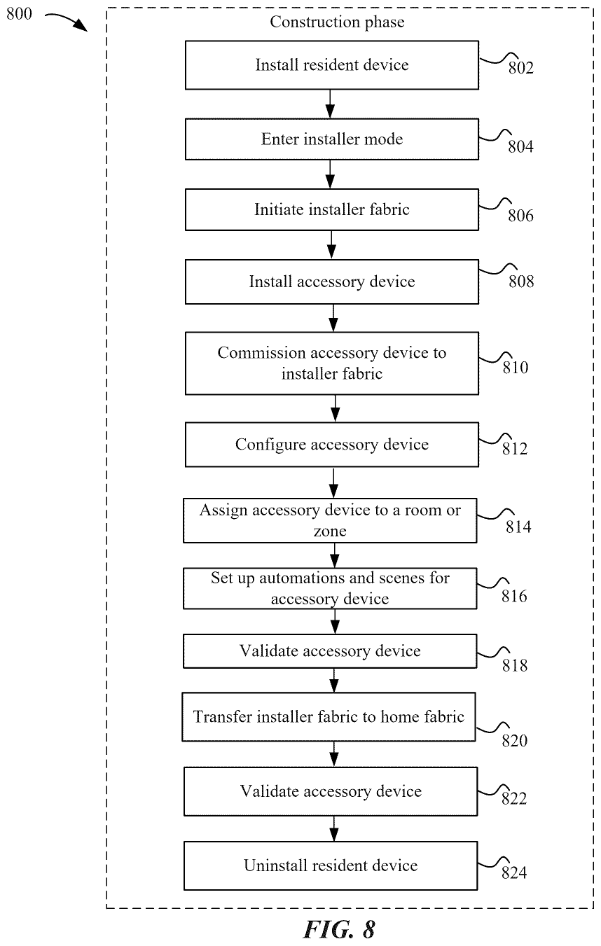

In some embodiments, the installer mode is activated in response to the resident device detecting an input, such as a button press, a voice command, an option in a settings menu of the resident device, and/or an air gesture. In such embodiments, in response to or after detecting the input, the resident device can pair with the installer device to communicate information between the resident device and the installer device in a secure manner. For example, the resident device can present a QR code that includes connection information (e.g., WiFi data, Bluetooth data, and/or Thread data) that the installer device can scan to establish a connection with the resident device. In another example, the resident device can initiate a Bluetooth advertisement that includes connection information to enable pairing. After scanning the QR code or detecting the Bluetooth advertisement, the installer device can pair with the resident device (e.g., through a handshake such as via an exchange of keys) and/or establish a communication channel with the local server of the resident device using the connection information. In some embodiments, in response to or after detecting the input, the installer device connects to a network address of the resident device to establish a TCP connection with the local server of the resident device. In such embodiments, the local server can be communicated with via one of multiple communication methods, such as WiFi, a software enabled access point (SoftAP), or Bluetooth. In some embodiments, the installer device maintains connection with the local server of the resident device throughout steps of process 700. In some embodiments, the local server provides the installer device with information needed for setup of one or more accessory devices, such as Thread credentials, WiFi network information, Bluetooth credentials, and/or a list of security credentials. In some embodiments, the installer device uses this information to set up an installer fabric and/or prepare for further accessory commissioning as further described below with respect to FIG. 8. In some embodiments, entering the installer mode, pairing with the installer device, and/or communicating between the installer device and/or the resident device requires authentication, such as a passcode and/or biometric verification for verifying an authorized installer.

After and/or in response to the resident device entering the installer mode, process 700 includes initializing (706) one or more home fabrics. In some embodiments, multiple home fabrics are initialized at 706. For example, the resident device can initialize an administrative fabric for coordinating removal, addition, and/or modification of one or more other home fabrics, an ecosystem-specific fabric that is a specific to an accessory device ecosystem, and/or an operation-specific fabric for specific accessory device functions, such as a power fabric that can be used to manage accessory devices with manageable power consumption.

After initializing the one or more home fabrics, process 700 includes setting up (708) rooms and zones. For example, the installer can define different rooms and/or zones of a home, such as “Living Room” and/or “Kitchen,” within the resident device. In some embodiments, zones can be created to group multiple rooms and/or areas together, such as “Upstairs” or “Outdoor.” For example, the installer can create a “Downstairs” zone that includes a living room, kitchen, and/or a dining room. In some embodiments, the resident device stores zone and/or room information that can be accessed by installers and/or homeowners during future accessory installations via the resident device. It should be recognized that other settings can be configured with respect to the home, such as names of networks, passwords, and/or limitations.

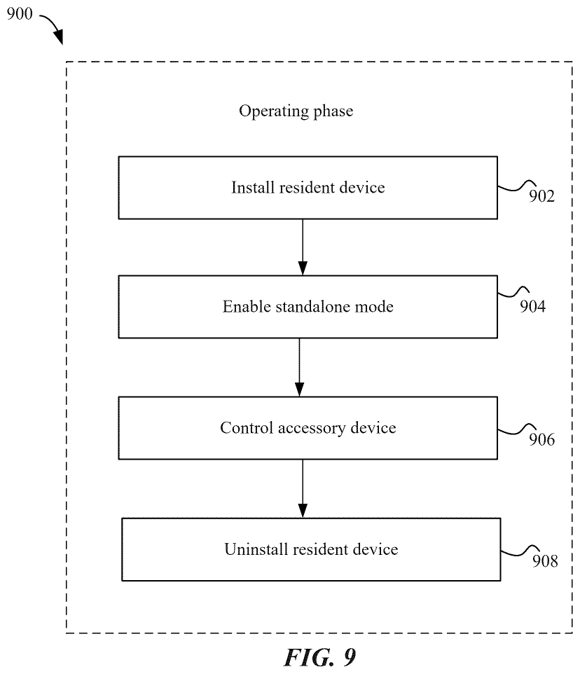

After rooms and/or zones are set up, process 700 includes uninstalling (710) the resident device. This optional step can be taken as a security measure to protect the resident device from damage, theft, and/or unauthorized access. For example, the resident device can be removed from a mount and/or be stored in a secure location until following phases of the home accessory ecosystem setup process take place, as described below with respect to FIGS. 8, 9 and/or 10. In some embodiments, uninstalling the resident device includes powering down, disconnecting from power sources, and/or physically removing the resident device from an installed location. In some embodiments, uninstalling the resident device does not erase the one or more home fabrics and/or the zone and/or room information to allow for continuation of processes when the resident device is reinstalled.

FIG. 8 illustrates a diagram of an exemplary process for a construction phase of a home accessory ecosystem in accordance with some embodiments. It should be recognized that, while process 800 is described as a series of discrete steps, one or more steps of process 800 can be omitted, performed in a different order, combined, and/or further subdivided. Process 800 includes use of a resident device (e.g., as described above with respect to FIG. 7) and a device referred to as an installer device. In some embodiments, the installer device is (1) separate from the resident device and (2) a device that configures one or more accessory devices with respect to the home accessory ecosystem for an environment, such as a home, an office, and/or a defined space. Examples of the installer device include a watch, a phone, a tablet, a fitness tracking device, a processor, a head-mounted display (HMD) device, a communal device, a media device, a speaker, a television, an electronic device, and/or a personal computing device.

Process 800 begins with installing (802) the resident device. In some embodiments, the resident device is installed similarly to as described above with respect to 702 of FIG. 7. After installing the resident device, process 800 includes entering (804) the resident device into an installer mode. In some embodiments, the resident device enters the installer mode similarly to as described above with respect to 704 of FIG. 7.

After the resident device enters the installer mode, process 800 proceeds with initiating (806) one or more installer fabrics (e.g., at least partially separate and/or distinct from the one or more home fabrics described above with respect to process 700). In some embodiments, an installer fabric is established on and/or via the installer device and represents a temporary collection of configurations, such as including configurations of a set of accessory devices, network infrastructure and/or communication protocols that can be used by the installer device to set up and configure one or more accessory devices before transferring the one or more accessory devices to one or more home fabrics (e.g., such as described above with respect to FIG. 7). In some embodiments, multiple home fabrics are initialized at 806. For example, the installer device can initialize an administrative fabric for coordinating removal, addition, and/or modification of one or more other installer fabrics, an ecosystem-specific fabric that is a specific to an accessory device ecosystem, and/or an operation-specific fabric for specific accessory device functions, such as a power fabric that can be used to manage accessory devices with manageable power consumption. In some embodiments, initiating the installer fabric includes establishing one or more communication channels between the installer device and one or more accessory devices, configuring one or more temporary security protocols, and/or defining one or more temporary network boundaries. For example, the installer fabric can use Wi-Fi, Thread, and/or other wireless communication for connecting with one or more accessory devices. In some embodiments, the installer device can connect to a local server running on the resident device and/or pair with the resident device by scanning a QR code and/or detecting a Bluetooth advertisement as described above with respect to process 700. In some embodiments, the local server of the resident device provides information such as Thread, Bluetooth, Wi-Fi credentials, and/or a list of pre-configured zones and/or rooms. In some embodiments, the installer device can use this information to set up the one or more installer fabrics and/or prepare for further accessory commissioning.

After initiating the one or more installer fabrics, process 800 includes installing (808) an accessory device (e.g., a smart light, thermostat, door lock, and/or camera). In some embodiments, installing the accessory device includes placing the accessory device within physical boundaries of a home, mounting the accessory device to a surface, connecting the accessory device to a power source, and/or powering on the accessory device. It should be recognized that multiple accessory devices can be installed, including different accessory devices compatible with different ecosystems and/or network protocols.

After the accessory device is installed, process 800 includes commissioning (810) the accessory device to the installer fabric. In some embodiments, commissioning the accessory device includes the installer device establishing a secure connection and/or pairing with the accessory device. For example, the installer device can scan a QR code displayed on the accessory device that contains pairing information. For another example, the installer device and the accessory device can use near-field communication (NFC) to establish a connection. For another example, the accessory device can advertise presence via Bluetooth to allow the installer device to detect and establish a Bluetooth pairing. For another example, in cases where automated methods are not available, the accessory device can display a pairing code that can be manually entered into the installer device. Once paired, the installer device proceeds to commission the accessory device onto the one or more installer fabrics. In some embodiments, the installer device uses network information previously obtained from a local server (e.g., as described above with respect to process 700) of the resident device to help establish this connection. For example, the installer device can provide the accessory device with WiFi or Thread network credentials to allow the accessory device to join a home network. In some embodiments, the installer device then establishes necessary security credentials for the accessory device to operate within the one or more installer fabrics.

In some embodiments, the installer device commissions multiple accessories in succession on at least one of the one or more installer fabrics without needing to interact with the resident device between each commissioning. In other embodiments, after commissioning an accessory device onto the installer fabric, the installer device notifies and/or synchronizes with the resident device on a newly commissioned accessory device, including information to later recommission the accessory device onto one or more home fabrics (e.g., as described above with respect to process 700).

After commissioning the accessory device onto the installer fabric, process 800 includes configuring (812) the accessory device. In some embodiments, configuring the accessory device can include setting up accessory device-specific features, assigning unique identifiers, and/or updating device firmware. For example, the installer device can set initial parameters for the accessory device, such as brightness levels for a smart light, temperature thresholds for a thermostat, and/or sensitivity settings for a motion sensor.

After configuring the accessory device, process 800 includes assigning (814) accessory device to a room or a zone. This step can leverage pre-configured zone and/or room information stored on the resident device that were added during the installation phase as described above with respect to 708. In some embodiments, new rooms and/or zones can be added to the installer fabric at 814. In some embodiments, assigning the accessory device to a room or zone helps organize accessory devices logically within the home accessory ecosystem and/or enables room-based or zone-based controls and automations. In some embodiments, the installer device can access a pre-defined list of zones and/or rooms via an installer application on the installer device that is in communication with the resident device. When assigning an accessory to a room or zone, the installer device can select from the pre-defined list of options defined during the resident device setup or by adding a room or zone. For example, if a smart light switch is being installed in the kitchen, the installer device can assign it to a “Kitchen” room. Similarly, if a thermostat is being installed to control an upstairs area, the thermostat can be assigned to an “Upstairs” zone that can include multiple rooms.

After the accessory device is assigned to a zone and/or a room, process 800 includes setting up (816) automations and scenes for the accessory device. For example, the installer can create automations such as turning on a light at sunset and/or adjusting a thermostat based on occupancy and/or a time of day. In some embodiments, scenes can be set up to control multiple accessory devices simultaneously, such as a “Good Morning” scene that opens blinds, turns on lights, and/or starts a coffee maker. In some embodiments, automations and/or scenes are initially set up on at least one of the one or more installer fabrics and can be transferred to at least one of the one or more home fabrics in a later step as further described below. In some embodiments, one or more automations and/or scenes are set up on the home fabric (e.g., after 820) in addition to or instead of as described with respect to 816 above.

After setting up automations and scenes, process 800 includes validating (818) the accessory device. In some embodiments, validating the accessory device includes checking network connectivity, verifying sensor readings, and/or confirming that the accessory device can respond to commands. For example, the installer device can test one or more accessory devices on at least one of the one or more installer fabrics.

After the accessory device is validated, process 800 includes transferring (820) the one or more installer fabrics to the one or more home fabrics. In some embodiments, the installer device uses the local server connection and/or pairing with the resident device, as described above with respect to FIG. 7, to initiate transfer of accessory devices from the one or more installer fabrics to the one or more home fabrics. In some embodiments, the transfer is initiated by exchanging a commissioning and/or recommissioning code and/or other recommissioning data from the accessory device to the installer device to the resident device and back to the accessory device. In some embodiments, the local server remains active during the entire installation process and allows the installer device to recommission multiple accessories in succession while maintaining a single connection to the resident device. As part of transferring the one or more installer fabrics to the one or more home fabrics, the resident device initiates a recommissioning process to add accessory devices to the one or more home fabrics. In some embodiments, the recommissioning process begins with the installer device sending a request to an accessory device to enter recommissioning mode. After receiving the request, the accessory device generates and returns recommissioning data that includes an Enhanced Commissioning Method (ECM) code. The installer device then transmits the recommissioning data, including the ECM code, to the resident device. Using the ECM code, the resident device can locate the accessory device on the network and execute recommissioning of the accessory device onto the one or more home fabrics. In some embodiments, in the case of recommissioning multiple accessory devices from the one or more installer fabrics onto the one or more home fabrics, the installer device transfers accessory devices in separate requests or batch transfers multiple accessory devices in a single request.

In some embodiments, transfer of an accessory device from the one or more installer fabrics to the one or more home fabrics includes reassigning network addresses, updating security credentials, and/or verifying transferred information, such as an accessory device name, identifier, zone and/or room assignments, and/or configurations. In some embodiments, setup and/or configuration parameters are maintained while securely transitioning an accessory device to the one or more home fabrics. In some embodiments, after successful transfer, process 800 implements an eviction policy. In such embodiments, the eviction policy can automatically remove an association of the installer device with one or more accessory devices and/or allow the installer device to initiate a completion action that removes access of the installer device to one or more accessory device. At this point, an accessory device that was originally commissioned on the one or more installer fabrics has been successfully transferred to the one or more home fabrics associated with the resident device. In some embodiments, the resident device can now directly control the accessory device. In some embodiments, transfer can be repeated for different accessories and/or can support multi-fabric accessory devices, where one or more accessory devices might need to be recommissioned to one or more additional fabrics, such as a separate energy management system, alongside the one or more home fabrics.

After transferring the accessory device from the one or more installer fabrics to the one or more home fabrics, process 800 includes validating (822) the accessory device on at least one of the one or more home fabrics. For example, an installer can perform a comprehensive check of transferred accessory devices, configurations such as assigned zones and/or rooms, and/or proper functionality of automations and scenes. In some embodiments, validating the accessory device at 822 ensures that the one or more home fabrics include all accessories and/or configurations transferred from the one or more installer fabrics and/or that the one or more home fabrics are functioning as intended for homeowner use.

After validating the accessory device on the one or more home fabrics, process 800 includes uninstalling (824) the resident device. In some embodiments, uninstalling the resident device is taken as a security measure to protect the resident device from damage and/or theft, and/or protect the home fabric from unauthorized access during a remainder of a construction and/or renovation process. For example, the resident device can be removed from a mount and stored in a secure location until a next phase of the home accessory ecosystem setup process is initiated, as described further below with respect to FIGS. 9 and/or 10. In some embodiments, uninstalling the resident device includes powering down, disconnecting from power sources, and/or physically removing the resident device from an installed location.

It should be recognized that while one installer device is described above, multiple different installer devices can be used with techniques described herein, each different installer device transferring different accessories on the same one or more installer fabrics and/or different accessories on different installer fabrics to the one or more home fabrics.

FIG. 9 illustrates a diagram of an exemplary process for an operation phase of a home accessory ecosystem in accordance with some embodiments. It should be recognized that, while process 900 is described as a series of discrete steps, one or more steps of process 900 can be omitted, performed in a different order, combined, and/or further subdivided. Process 900 includes use of a resident device (e.g., as described above with respect to FIGS. 7-8).

Process 900 begins with installing (902) the resident device. In some embodiments, the resident device is installed similarly to as described above with respect to 702 of FIGS. 7 and/or 802 of FIG. 8.

After installing the resident device, process 900 includes enabling (904) a standalone mode. In some embodiments, the standalone mode allows the resident device to operate independently without requiring communication to external servers, applications, and/or devices, such as an installer device (e.g., as described above with respect to FIG. 8). For example, in the standalone mode, the resident device can manage local control of accessory devices, execute automations, and/or process user commands via the one or more home fabrics that were preconfigured on the resident device. In some embodiments, the standalone mode is activated in response to the resident device detecting an input, such as a button presses, a voice command, an option in a settings menu of the resident device, and/or an air gesture.

After the standalone mode is enabled, process 900 includes controlling (906) an accessory device. For example, the resident device can send one or more commands to the accessory device, receive status updates from the accessory device, and/or execute automations and/or scenes set up during the construction phase for the accessory device (e.g., as described above with respect to FIG. 8). In some embodiments, controlling the accessory device includes responding to user input detected via the resident device and/or user input detected via another device, such as a mobile device, connected to the resident device and/or to a home network. In such embodiments, the other device can pair and/or open a communication channel with the resident device to control the accessory device via the resident device using the one or more home fabrics without requiring input detected via the resident device itself. For example, a user can command the resident device to turn on lights in a specific room, adjust a thermostat, and/or activate a predefined scene. For another example, a user can open a home application on the other device that displays a status of the accessory device, such as real-time energy consumption from power monitoring accessories and/or a current state of a light. The home application can communicate these commands to the resident device and, then, the resident device executes the commands by communicating with the accessory device.

After controlling the accessory device, process 900 includes uninstalling (908) the resident device. In some embodiments, this step can be executed when the home accessory ecosystem needs to be reconfigured, when the resident device needs to be replaced, and/or when a home is being prepared for a new occupant. For example, the resident device can be removed from a mount and/or stored away. In some embodiments, uninstalling the resident device includes powering down, disconnecting from power sources, and/or physically removing the resident device from an installed location. In some embodiments, uninstalling the resident device includes removing data related to one or more installer fabrics and/or one or more home fabrics to protect user and/or home data privacy.

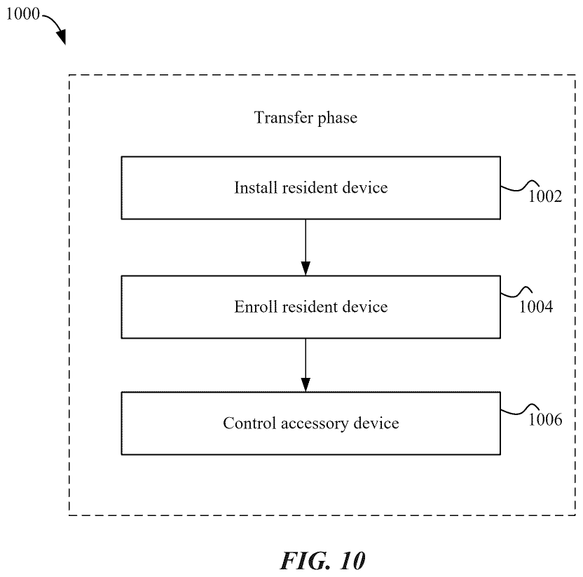

FIG. 10 illustrates a diagram of an exemplary process for a transfer phase of a home accessory ecosystem in accordance with some embodiments. It should be recognized that, while process 1000 is described as a series of discrete steps, one or more steps of process 800 can be omitted, performed in a different order, combined, and/or further subdivided. Process 800 includes use of a resident device (e.g., as described above with respect to FIGS. 7-9).

Process 1000 begins with installing (1002) the resident device. In some embodiments, the resident device is installed similarly to as described above with respect to 702 of FIGS. 7, 802 of FIG. 8, and/or 902 of FIG. 9.

After installing the resident device, process 1000 includes enrolling (1004) the resident device. For example, the resident device is enrolled in response to the resident device or a personal device in communication with the resident device detecting an input, such as a button press, a voice command, an option in a settings menu, and/or an air gesture. In some embodiments, enrolling the resident device includes associating the resident device with a user account, configuring network settings, and/or restoring previously saved settings and/or configurations. For example, a new occupant can enroll the resident device to a personal account for controlling the home accessory ecosystem. In some embodiments, enrolling the resident device 1004 includes restoring and/or reactivating one or more home fabrics (e.g., as described above with respect to FIGS. 7-9) on the resident device and/or assigning authorization to the one or more home fabrics to a new user, such as the new occupant. In some embodiments, when a new user is being added to the one or more home fabrics, the resident device initiates a process to add one or more devices of the new user to the one or more home fabrics. In some embodiments, different users are granted different levels of access. For example, a primary user can have access to an administrative fabric while other users might be restricted to specific fabrics and/or have limited control capabilities of the administrative fabric. In some embodiments, when multiple users are enrolled, the resident device maintains separate security credentials for each user while ensuring all enrolled users can access and control one or more accessory devices included in the one or more home fabrics according to their assigned permissions. In some embodiments, the resident device supports addition of temporary users, such as guests and/or maintenance personnel, with time and/or security limited access to specific fabrics. It should be recognized that enrolling the resident device can involve additional sub-steps such as network configuration, account specific user authentication steps, and/or restoration of previous settings.

After enrollment of the resident device, process 1000 includes controlling (1006) an accessory device. For example, the resident device can send commands to the accessory device, receive status updates from the accessory device, and/or execute automations and/or scenes that were previously set up for the accessory device as described above with respect to FIGS. 7 and/or 8. In some embodiments, controlling the accessory device includes responding to user inputs detected via the resident device and/or user inputs detected via a user device, such as a mobile device, connected to the resident device and/or a home network.

In some embodiments, a new occupant uses a home application on their mobile device to control and/or display a status of the accessory device. In such embodiments, the resident device can act as a secure intermediary that ensures commands and/or status requests are authenticated using security permissions granted during enrollment. In some embodiments, through the home application, the new occupant monitors aspects of the home accessory ecosystem, such as viewing security camera feeds, door lock statuses, and/or monitoring temperature settings across different zones and/or rooms. In such embodiments, the home application can send these requests to the resident device that then retrieves information from one or more accessory devices and returns statuses back to the home application. For another example, the new occupant can use their device to send commands to control accessory devices that are routed through the resident device. The device of the new occupant sends the command to the resident device that then communicates with one or more appropriate accessory using security permissions established during enrollment. For example, the new occupant can send a command from their mobile device to turn on lights in a specific room, adjust a thermostat, and/or activate a predefined scene, and the resident device will execute the command on behalf of the device of the new occupant.

In some embodiments, process 1000 can include additional steps not illustrated in FIG. 10, such as reconfiguring accessory devices, updating automations and/or scenes to suit preferences of a new occupant, and/or performing a system-wide check to ensure all components of the home accessory ecosystem are functioning correctly. For example, after enrolling the resident device, a new occupant can customize existing scenes and/or create new scenes.

In some embodiments, the accessory device is a first accessory device. In some embodiments, the connection information is first connection information. In some embodiments, the electronic device receives (e.g., before, after, or while commissioning the first accessory device on the set of one or more security domains and/or before or after receiving the request to commission the first accessory device), from the installer device, a request to commission a second accessory device (e.g., an accessory device as described with respect to and/or as illustrated in FIGS. 3C-3K) (e.g., a device configured to be controlled by one or more other devices), wherein the request to commission the second accessory device includes second connection information (e.g., a code, a credential, an identifier, a name, and/or address information) corresponding to the second accessory device, wherein the second accessory device is different from the installer device, the electronic device, and the first accessory device. In some embodiments, the second accessory device is a display, a television, a light, a lock, a security system, a speaker, an appliance, and/or a thermostat. In some embodiments, the request to commission the second accessory device is sent as a part of causing the accessory device to be recommissioned on the second set of one or more security domains using the recommissioning data as described above with respect to process 500. In some embodiments, the second accessory device is commissioned on one or more security domains (e.g., as described above with respect to the first set of one or more security domains of process 500) while the electronic device receives the request to commission the second accessory device. In some embodiments, the second connection information is the same as or different from the first connection information. In some embodiments, in response to receiving the request to commission the second accessory device, the electronic device establishes, with the second accessory device, a connection using the second connection information (and/or communicates with the second accessory device). In some embodiments, the connection using the second connection information is established via a network (sometimes referred to as an operational network) that includes the second accessory device and the electronic device. In some embodiments, the second accessory device and the electronic device are on the network before receiving the request to commission the second accessory device. In some embodiments, the network includes an Internet network, a cellular network, a wired network, a wireless network, a WiFi network, and/or a Thread network. In some embodiments, establishing the connection using the second connection information includes identifying, using the second connection information, the second accessory device on the network and/or communicating, via the network, with the second accessory device. In some embodiments, in response to receiving the request to commission the second accessory device, the electronic device Commissions (e.g., provisions, adds, registers, and/or establishes), using the second connection, the second accessory device on the set of one or more security domains. In some embodiments, commissioning the second accessory device on the set of one or more security domains includes registering the second accessory device on the set of one or more security domains (e.g., each security domain included in the set of one or more security domains). In some embodiments, the electronic device, after commissioning, communicates with the second accessory device using the network. In some embodiments, commissioning the second accessory device on a single security domain includes providing, to the second accessory device, one or more credentials to be used by the second accessory device to communicate with other devices in the single security domain.

In some embodiments, the accessory device is a first accessory device. In some embodiments, the connection information is first connection information. In some embodiments, the installer device is a first installer device. In some embodiments, the electronic device receives (e.g., before, after, or while commissioning the first accessory device on the set of one or more security domains and/or before or after receiving the request to commission the first accessory device), from a second installer device (e.g., an installation device, an electronic device, a computer system, a user device, a commissioning device, and/or a controller device), a request to commission a third accessory device(e.g., an accessory device as described with respect to and/or as illustrated in FIGS. 3C-3K) (e.g., a device configured to be controlled by one or more other devices), wherein the request to commission the third accessory device includes third connection information (e.g., a code, a credential, an identifier, a name, and/or address information) corresponding to the third accessory device, wherein the third accessory device is different from the first installer device, the second installer device, the electronic device, and the first accessory device (and/or the second accessory device), and wherein the second installer device is different from the electronic device and the first installer device. In some embodiments, the third accessory device is a display, a television, a light, a lock, a security system, a speaker, an appliance, and/or a thermostat. In some embodiments, the request to commission the third accessory device is sent as a part of causing the accessory device to be recommissioned on the second set of one or more security domains using the recommissioning data as described above with respect to process 500. In some embodiments, the third accessory device is commissioned on one or more security domains (e.g., as described above with respect to the first set of one or more security domains of process 500) while the electronic device receives the request to commission the third accessory device. In some embodiments, the third connection information is the same as or different from the first connection information and/or the second connection information. In some embodiments, in response to receiving the request to commission the third accessory device, the electronic device establishes, with the third accessory device, a connection using the third connection information (and/or communicates with the third accessory device). In some embodiments, the connection is established via a network (sometimes referred to as an operational network) that includes the third accessory device and the electronic device. In some embodiments, the third accessory device and the electronic device are on the network before receiving the request to commission the third accessory device. In some embodiments, the network includes an Internet network, a cellular network, a wired network, a wireless network, a WiFi network, and/or a Thread network. In some embodiments, establishing the connection using the third connection information includes identifying, using the third connection information, the third accessory device on the network and/or communicating, via the network, with the third accessory device. In some embodiments, in response to receiving the request to commission the third accessory device, the electronic device commissions (e.g., provisions, adds, registers, and/or establishes), using the third connection, the third accessory device on the set of one or more security domains. In some embodiments, commissioning the third accessory device on the set of one or more security domains includes registering the third accessory device on the set of one or more security domains (e.g., each security domain included in the set of one or more security domains). In some embodiments, the electronic device, after commissioning, communicates with the third accessory device using the network. In some embodiments, commissioning the third accessory device on a single security domain includes providing, to the third accessory device, one or more credentials to be used by the third accessory device to communicate with other devices in the single security domain.

In some embodiments, the accessory device is a first accessory device. In some embodiments, the connection information is first connection information. In some embodiments, the set of one or more security domains is a first set of one or more security domains. In some embodiments, the electronic device receives (e.g., before, after, or while commissioning the first accessory device on the first set of one or more security domains and/or before or after receiving the request to commission the first accessory device), from the installer device, a request to commission a fourth accessory device(e.g., an accessory device as described with respect to and/or as illustrated in FIGS. 3C-3K) (e.g., a device configured to be controlled by one or more other devices), wherein the request to commission the fourth accessory device includes fourth connection information (e.g., a code, a credential, an identifier, a name, and/or address information) corresponding to the fourth accessory device, wherein the fourth accessory device is different from the installer device, the electronic device, and the first accessory device (and/or the second accessory device and/or the third accessory device). In some embodiments, the fourth accessory device is a display, a television, a light, a lock, a security system, a speaker, an appliance, and/or a thermostat. In some embodiments, the request to commission the fourth accessory device is sent as a part of causing the accessory device to be recommissioned on the second set of one or more security domains using the recommissioning data as described above with respect to process 500. In some embodiments, the fourth accessory device is commissioned on one or more security domains (e.g., as described above with respect to the first set of one or more security domains of process 500) while the electronic device receives the request to commission the fourth accessory device. In some embodiments, the fourth connection information is the same as or different from the first connection information, the second connection information, and/or the third connection information. In some embodiments, in response to receiving the request to commission the fourth accessory device, the electronic device establishes, with the fourth accessory device, a connection using the fourth connection information (and/or communicates with the fourth accessory device). In some embodiments, the connection using the fourth connection information is established via a network (sometimes referred to as an operational network) that includes the fourth accessory device and the electronic device. In some embodiments, the fourth accessory device and the electronic device are on the network before receiving the request to commission the fourth accessory device. In some embodiments, the network includes an Internet network, a cellular network, a wired network, a wireless network, a WiFi network, and/or a Thread network. In some embodiments, establishing the connection using the fourth connection information includes identifying, using the fourth connection information, the fourth accessory device on the network and/or communicating, via the network, with the fourth accessory device. In some embodiments, in response to receiving the request to commission the fourth accessory device, the electronic device commissions (e.g., provisions, adds, registers, and/or establishes), using the fourth connection, the fourth accessory device on a second set of one or more security domains (e.g., fabrics, secure communication networks, and/or groups) different from the first set of one or more security domains. In some embodiments, commissioning the fourth accessory device on the second set of one or more security domains includes registering the fourth accessory device on the second set of one or more security domains (e.g., each security domain included in the second set of one or more security domains). In some embodiments, the electronic device, after commissioning, communicates with the fourth accessory device using the network. In some embodiments, commissioning the fourth accessory device on a single security domain includes providing, to the fourth accessory device, one or more credentials to be used by the fourth accessory device to communicate with other devices in the single security domain. In some embodiments, the second set of one or more security domains includes an administrative domain (e.g., a domain that is used to coordinate addition of other security domains) and/or one or more ecosystem-specific domains (e.g., a domain specific to an application and/or a company). In some embodiments, the second set of one or more security domains corresponds to, is administered by, is controlled by, is associated with, and/or is owned by the electronic device. In some embodiments, the second set of one or more security domains includes at least one security domain included in the first set of one or more security domains. In some embodiments, the first set of one or more security domains includes at least one security domain included in the second set of one or more security domains. In some embodiments, the second set of one or more security domains does not include a security domain included in the first set of one or more security domains. In some embodiments, the first set of one or more security domains does not include a security domain included in the second set of one or more security domains.

In some embodiments, before receiving the request to commission the accessory device, the electronic device connects to a network (e.g., an operational network, an Internet network, a cellular network, a wired network, a wireless network, a WiFi network, and/or a Thread network). In some embodiments, before receiving the request to commission the accessory device, the electronic device establishes (e.g., brings up, starts, initiates, and/or activates) a local server (and/or a port) on the electronic device (e.g., for communicating with one or more devices, such as the installer device). In some embodiments, while connected to the network, after establishing the local server, and before receiving the request to commission the accessory device, the electronic device connects, via the local server, to the installer device (e.g., establishes a TCP connection with the installer device using the local server), wherein the request to commission the accessory device is received by the electronic device via the local server (and/or the port). In some embodiments, instead of receiving the request to commission the accessory via the local server, the electronic device receives, from the installer device, the request to commission the accessory in a message, such as a direct message that is not part of an on-going connection.

In some embodiments, the connection established with the accessory device uses a different communication channel than the local server (e.g., communication between the electronic device and the accessory device is not through the local server).

In some embodiments, before receiving the request to commission the accessory device, the electronic device sends, to the installer device, a list of pre-configured groups of accessory devices (e.g., a list of rooms and/or zones), wherein the request, to commission the accessory device, includes an identification of a group of the list of pre-configured groups of accessory devices, and wherein the accessory device is commissioned on the set of one or more security domains as a part of the group.

In some embodiments, before receiving the request to commission the accessory device, the electronic device sends, to the installer device, a list of pre-configured groups of accessory devices (e.g., a list of rooms and/or zones), wherein the request, to commission the accessory device, includes an identification of a group that is not included in the list of pre-configured groups of accessory devices (e.g., the group is established and/or created by the installer device), and wherein the accessory device is commissioned on the set of one or more security domains as a part of the group.

In some embodiments, before receiving the request to commission the accessory device, the electronic device receives, from the installer device, a request to add an automation to the accessory device such that the accessory device is configured to perform one or more operations (e.g., turn on at a particular time, turn off at a particular, change states at a particular time, and/or change states in response to detecting a particular event) according to the automation. In some embodiments, the electronic device sends, to the accessory device, the request to add the automation to the accessory device (e.g., the request is sent through the electronic device, such as when the electronic device is acting a router for the installer device and/or the accessory device).

In some embodiments, the electronic device is a first electronic device. In some embodiments, after sending, to the accessory device, the request to add the automation to the accessory device, the electronic device receives, from a second electronic device (e.g., via the set of one or more security domains, such as using a credential that is part of the set of one or more security domains to communicate with the accessory device) different from the first electronic device, a request to modify the automation. In some embodiments, the second electronic device is a user device and/or a personal device that is taking over (e.g., from the first electronic device), becoming an owner or co-owner of, and/or becoming an administrator of the set of one or more security domains. In some embodiments, the second electronic device is a watch, a phone, a tablet, a fitness tracking device, a processor, a head-mounted display (HMD) device, a communal device, a media device, a speaker, a television, and/or a personal computing device. In some embodiments, in response to receiving the request to modify the automation, the electronic device modifies, via the accessory device, the automation. In some embodiments, in response to receiving the request to modify the automation, the first electronic device sends, to the accessory device, the request to modify the automation (e.g., the request to modify the automation is sent through the first electronic device, such as when the first electronic device is acting a router for the second electronic device and/or the accessory device).

In some embodiments, after (and/or in response to) commissioning the accessory device on the set of one or more security domains (and/or without detecting user input corresponding to a request to remove access), the electronic device removes access to the accessory device by the installer device (e.g., after removing access to the accessory device, the electronic device is no longer able to obtain a status of the accessory device and/or control the accessory device). In some embodiments, access to the accessory device is removed without detecting user input. In some embodiments, access to the accessory device is removed in response to detecting user input corresponding to a request to remove access to the accessory device.

In some embodiments, after (and/or in response to) commissioning the accessory device on the set of one or more security domains (and/or without detecting user input corresponding to a request to remove access), the electronic device receives, from a third electronic device (e.g., 300) different from the first electronic device, a request to commission the third electronic device on the set of one or more security domains. In some embodiments, the third electronic device is a user device and/or a personal device that is taking over (e.g., from the first electronic device), becoming an owner or co-owner of, and/or becoming an administrator of the set of one or more security domains. In some embodiments, the third electronic device is a watch, a phone, a tablet, a fitness tracking device, a processor, a head-mounted display (HMD) device, a communal device, a media device, a speaker, a television, and/or a personal computing device. In some embodiments, the third electronic device is not an accessory device. In some embodiments, in response to receiving the request to commission the third electronic device on the set of one or more security domains, the electronic device commissions the third electronic device on the set of one or more security domains. In some embodiments, commissioning the third electronic device on the set of one or more security domains includes registering the third electronic device on the set of one or more security domains (e.g., each security domain included in the set of one or more security domains). In some embodiments, the third electronic device, after commissioning, communicates with the accessory device using the network. In some embodiments, commissioning the third electronic device on a single security domain includes providing, to the third electronic device, one or more credentials to be used by the third electronic device to communicate with other devices in the single security domain.

In some embodiments, the set of one or more security domains include multiple security domains. In some embodiments, the multiple security domains include a first security domain and a second security domain different from the first security domain. In some embodiments, the first security domain uses a first set of one or more credentials for communicating. In some embodiments, the second security domain uses a second set of one or more credentials for communicating. In some embodiments, the second set of one or more credentials is different from the first set of one or more credentials.

In some embodiments, after commissioning the accessory device on the set of one or more security domains, the electronic device receives a request to change a set of one or more credentials (e.g., a username, a password, and/or a certificate) for a network (e.g., an operational network, an Internet network, a cellular network, a wired network, a wireless network, a WiFi network, and/or a Thread network) corresponding to the accessory device. In some embodiments, the request to change the set of one or more credentials for the network corresponding to the accessory device is received from the installer device, the accessory device, or another device different from the accessory device and the installer device. In some embodiments, the other device is a user device and/or a personal device that is taking over (e.g., from the electronic device), becoming an owner or co-owner of, and/or becoming an administrator of the set of one or more security domains. In some embodiments, the other electronic device is a watch, a phone, a tablet, a fitness tracking device, a processor, a head-mounted display (HMD) device, a communal device, a media device, a speaker, a television, and/or a personal computing device. In some embodiments, the other electronic device is not an accessory device. In some embodiments, the installer device, the electronic device, the other electronic device, and/or the accessory device communicate via the network. In some embodiments, in response to receiving the request to change the set of one or more credentials for the network corresponding to the accessory device, the electronic device changes the set of one or more credentials for the network corresponding to the accessory device (e.g., in accordance with the request to change the set of one or more credentials for the network corresponding to the accessory device).

In some embodiments, after commissioning the accessory device on the set of one or more security domains, the electronic device receives, from a user device different from the accessory device, the installer device, and the electronic device, a request to be added to a security domain (e.g., an administrative domain (e.g., a domain that is used to coordinate addition of other security domains) and/or an ecosystem-specific domain (e.g., a domain specific to an application and/or a company)) of the set of one or more security domains. In some embodiments, in response to receiving the request to be added to the security domain, the electronic device commissions the user device on the security domain. In some embodiments, commissioning the user device on the security domain includes registering the accessory device on the security domain. In some embodiments, commissioning the user device on the security domain includes providing, to the accessory device, one or more credentials to be used by the accessory device to communicate with other devices in the security domain. In some embodiments, after commissioning the accessory device on the set of one or more security domains, the electronic device receives, from the user device, a request to be added to the one or more security domains. In some embodiments, in response to receiving the request to be added to the set of one or more security domains, the electronic device commissions the user device on the set of one or more security domains. In some embodiments, commissioning the user device on the set of one or more security domains includes registering the accessory device on the set of one or more security domains (e.g., each security domain included in the set of one or more security domains). In some embodiments, the user device is provided control of the accessory device as a result of being commissioned on the security domain and/or the set of one or more security domains. In some embodiments, the user device is taking over (e.g., from the electronic device), becoming an owner or co-owner of, and/or becoming an administrator of the security domain and/or the set of one or more security domains. In some embodiments, the user device is a watch, a phone, a tablet, a fitness tracking device, a processor, a head-mounted display (HMD) device, a media device, a speaker, a television, a controller, and/or a personal computing device. In some embodiments, the user device is not an accessory device.

In some embodiments, after commissioning the accessory device on the set of one or more security domains, the electronic device receives, from a user device different from the accessory device, the installer device, and the electronic device, a request to add an additional security domain (e.g., an ecosystem-specific domain, such as a domain specific to an application and/or a company) to the set of one or more security domains. In some embodiments, in response to receiving the request to add the additional security domain to the set of one or more security domains, the electronic device maintains at least one existing security domain in the set of one of more security domains. In some embodiments, in response to receiving the request to add the additional security domain to the set of one or more security domains, the electronic device commissions the accessory device on the additional security domain. In some embodiments, in response to receiving the request to add the additional security domain to the set of one or more security domains, the electronic device commissions one or more other devices on the additional security domain. In some embodiments, the one or more other devices are already commissioned on the set of one or more security domains while receiving the request to add the additional security domain to the set of one or more security domains. In some embodiments, in response to receiving the request to add the additional security domain to the set of one or more security domains, the electronic device decommissions an existing security domain (e.g., an ecosystem-specific domain, such as a domain specific to an application and/or a company, that is different from the additional security domain) in the set of one of more security domains.

Note that details of the processes described above with respect to process 600 (e.g., FIG. 6) are also applicable in an analogous manner to the processes described herein. For example, process 500 optionally includes one or more of the characteristics of the various processes described herein with reference to process 600. For example, the electronic device of process 600 can be the resident device of process 500. For brevity, these details are not repeated herein.

In some embodiments, one or more of processes 400, 500, and 600 (FIGS. 4, 5, and 6) is performed at a first computer system (as described herein) via a system process (e.g., an operating system process and/or a server system process) that is different from one or more applications executing and/or installed on the first computer system.

In some embodiments, one or more of processes 400, 500, and 600 (FIGS. 4, 5, and 6) is performed at a first computer system (as described herein) by an application that is different from a system process.

In some embodiments, the instructions of the application, when executed, control the first computer system to perform one or more of processes 400, 500, and 600 (FIGS. 4, 5, and 6) by calling an application programming interface (API) provided by the system process. In some embodiments, the application performs at least a portion of one or more of processes 400, 500, and 600 (FIGS. 4, 5, and 6) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform one or more of processes 400, 500, and 600 (FIGS. 4, 5, and 6) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform processes 400, 500, and 600 (FIGS. 4, 5, and 6) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to processes 400, 500, and 600 (FIGS. 4, 5, and 6).

In some embodiments, API 176 defines a first API call response that can be provided to an application by API calling instructions 174, wherein the first API call response includes parameters described above with respect to processes 400, 500, and 600 (FIGS. 4, 5, and 6).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve how a device interacts with a user. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed to users by inferring location based on non-personal information data or a bare minimum amount of personal information, such as the content being requested by the device associated with a user or other non-personal information.

What is claimed is:

1. A method, comprising:
at a computer system that is in communication with one or more input devices:
detecting, via the one or more input devices, an input corresponding to a request to add an accessory device to an ecosystem corresponding to a first application;
in response to detecting the input corresponding to the request to add the accessory device to the ecosystem, initiating a process to add the accessory device to the ecosystem, wherein the process to add the accessory device to the ecosystem includes:
in accordance with a determination that a second application is not installed on the computer system, initiating a process to install the second application, wherein the second application corresponds to the accessory device, and wherein the second application is different from the first application; and
in accordance with a determination that the second application is installed on the computer system, forgoing initiation of the process to install the second application; and
after installing the second application as part of the process to add the accessory device to the ecosystem and in accordance with a determination that a set of one or more automatic removal criteria is satisfied, removing the second application without detecting a user input to remove the second application.

2. The method of claim 1, wherein the computer system is in communication with one or more display generation components, the method further comprising:
in response to installing the second application, displaying, via the one or more display generation components, a user interface of the second application.

3. The method of claim 1, wherein the computer system is in communication with one or more display generation components, and wherein the input is detected while displaying, via the one or more display generation components, a user interface of a third application different from the second application.

4. The method of claim 3, wherein the third application is part of an operating system of the computer system.

5. The method of claim 3, wherein the third application is the first application.

6. The method of claim 4, wherein the accessory device is a first accessory device, the method further comprising:
after detecting the input corresponding to the request to add the first accessory device to the ecosystem of the first application, detecting, via the one or more input devices, an input corresponding to a request to add a second accessory device to the ecosystem corresponding to the first application, wherein the second accessory device is different from the first accessory device;
in response to detecting the input corresponding to the request to add the second accessory device to the ecosystem, initiating a process to add the second accessory device to the ecosystem, wherein the process to add the second accessory device to the ecosystem includes:
in accordance with a determination that a fourth application is not installed on the computer system, initiating a process to install the fourth application, wherein the fourth applications corresponds to the second accessory device, and wherein the fourth application is different from the first application and the second application; and
in accordance with a determination that the fourth application is installed on the computer system, forgoing initiation of the process to install the second application; and
after installing the fourth application as part of the process to add the second accessory device to the ecosystem and in accordance with a determination that the set of one or more automatic removal criteria is satisfied, removing the fourth application without detecting a user input to remove the fourth application.

7. The method of claim 1, wherein the computer system is in communication with one or more display generation components, wherein the input corresponding to the request to add the accessory device to the ecosystem is detected while displaying, via the one or more display generation components, a user interface, the method further comprising:
in response to detecting the accessory device in proximity to the computer system, displaying, via the one or more display generation components, the user interface.

8. The method of claim 1, wherein the computer system is in communication with one or more display generation components, wherein the input corresponding to the request to add the accessory device to the ecosystem is detected while displaying, via the one or more display generation components, a user interface, the method further comprising:
in response to scanning a Quick Response (QR) code, displaying, via the one or more display generation components, the user interface.

9. The method of claim 1, wherein the process to add the accessory device to the ecosystem includes:
connecting the accessory device to a network.

10. The method of claim 1, wherein, before removing the second application, the second application is not added to a list of applications installed on the computer system after installing the second application as part of the process to add the accessory device to the ecosystem.

11. The method of claim 1, wherein the second application is installed without entering a credential, the method further comprising:
detecting, via the one or more inputs devices, an input corresponding to a request to install a fifth application different from the first application and the second application, wherein the fifth application corresponds to the second application; and
in response to detecting the input corresponding to the request to install the fifth application, requesting one or more credentials to be provided to allow the fifth application to be installed.

12. The method of claim 1, wherein the computer system is in communication with one or more display generation components, the method further comprising:
after adding the accessory device to the ecosystem, displaying, via the one or more display generation components, a user interface of the first application, wherein the user interface includes a current status of the accessory device.

13. The method of claim 12, wherein the user interface of the first application includes a control corresponding to the accessory device, the method further comprising:
while displaying the user interface of the first application and the control corresponding to the accessory device, detecting, via the one or more input devices, an input corresponding to the control; and
in response to detecting the input corresponding to the control, changing a state of the accessory device in accordance with the input corresponding to the control.

14. The method of claim 1, wherein the process to add the accessory device to the ecosystem includes:
in accordance with a determination that the second application is not logged into at least one account, automatically creating, using a credential of the computer system, an account with the second application, wherein the account is created without detecting an input corresponding to selection of the credential.

15. The method of claim 1, wherein the computer system is in communication with one or more display generation components, and wherein the process to add the accessory device to the ecosystem includes concurrently displaying, via the one or more display generation components:
a first option to log into the second application using a credential of the computer system; and
a second option, separate from the first option, to log into an account of the second application.

16. The method of claim 1, wherein the process to add the accessory device to the ecosystem includes:
detecting, via the one or more input devices, an input corresponding to a request to assign an attribute to the accessory device; and
in response to detecting the input corresponding to the request to assign the attribute to the accessory device, assigning the attribute to the accessory device such that the attribute affects display of content corresponding to the accessory device.

17. The method of claim 16, wherein the attribute is assigned to the accessory device via the first application.

18. The method of claim 16, wherein the attribute is assigned to the accessory device via the second application.

19. The method of claim 1, wherein the computer system is in communication with one or more display generation components, and wherein the process to add the accessory device to the ecosystem includes displaying, via the one or more display generation components, a user interface of the first application.

20. The method of claim 19, wherein the user interface of the first application is displayed before initiating the process to install the second application.

21. The method of claim 19, wherein the user interface of the first application is displayed after initiating the process to install the second application.

22. A non-transitory computer-readable storage medium storing one or more programs configured to be executed by one or more processors of a computer system that is in communication with one or more input devices, the one or more programs including instructions for:
detecting, via the one or more input devices, an input corresponding to a request to add an accessory device to an ecosystem corresponding to a first application;
in response to detecting the input corresponding to the request to add the accessory device to the ecosystem, initiating a process to add the accessory device to the ecosystem, wherein the process to add the accessory device to the ecosystem includes:
in accordance with a determination that a second application is not installed on the computer system, initiating a process to install the second application, wherein the second application corresponds to the accessory device, and wherein the second application is different from the first application; and
in accordance with a determination that the second application is installed on the computer system, forgoing initiation of the process to install the second application; and
after installing the second application as part of the process to add the accessory device to the ecosystem and in accordance with a determination that a set of one or more automatic removal criteria is satisfied, removing the second application without detecting a user input to remove the second application.

23. A computer system configured to communicate with one or more input devices, the computer system comprising:
one or more processors; and
memory storing one or more programs configured to be executed by the one or more processors, the one or more programs including instructions for:
detecting, via the one or more input devices, an input corresponding to a request to add an accessory device to an ecosystem corresponding to a first application;
in response to detecting the input corresponding to the request to add the accessory device to the ecosystem, initiating a process to add the accessory device to the ecosystem, wherein the process to add the accessory device to the ecosystem includes:
in accordance with a determination that a second application is not installed on the computer system, initiating a process to install the second application, wherein the second application corresponds to the accessory device, and wherein the second application is different from the first application; and
in accordance with a determination that the second application is installed on the computer system, forgoing initiation of the process to install the second application; and
after installing the second application as part of the process to add the accessory device to the ecosystem and in accordance with a determination that a set of one or more automatic removal criteria is satisfied, removing the second application without detecting a user input to remove the second application.
